(19) United States
(12) Patent Application Publication
(10) Pub. No.: US 2023/0420949 A1
(43) Pub. Date: Dec. 28, 2023

(54) CHARGER CONNECTING TO ENERGY STORAGE DEVICE AND METHOD OF PROVIDING USER INTERFACE THEREOF

(71) Applicant: Standard Energy Inc., Daejeon (KR)

(72) Inventors: Bugi KIM, Daejeon (KR); Dongyoung LEE, Daejeon (KR)

(73) Assignee: Standard Energy Inc., Daejeon (KR)

(21) Appl. No.: 18/121,584

(22) Filed: Mar. 14, 2023

(30) Foreign Application Priority Data
Jun. 24, 2022 (KR) 10-2022-0077261
Jun. 24, 2022 (KR) 10-2022-0077265
Aug. 26, 2022 (KR) 10-2022-0107472
Nov. 1, 2022 (KR) 10-2022-0143901

(51) Int. Cl. H02J 3/32; B60L 53/66; B60L 53/63

(52) U.S. Cl. CPC H02J 3/322; B60L 53/665; B60L 53/63

(57) ABSTRACT

The present disclosure relates to a charger connecting to an energy storage device, and a method of providing a user interface thereof, and the charger of one embodiment comprises a power supply part receiving electric power from any one or more supply source of a grid or an energy storage device, an interface part providing an interface for selecting any one of a charge cost method or a charge period method and an interface for setting a charge cost or a charge period, based on the selected method, a charger controller determining a charging price unit of a charge cost or a charge period depending on the sort of a supply source, and a charge part proceeding with charge based the period or cost selected at the interface part.

### CROSS-REFERENCE TO RELATED APPLICATION

This application claims priority to and the benefit of Korean Patent Application No. 10-2022-0143901, filed on Nov. 1, 2022, Korean Patent Application No. 10-2022-0077261, filed on Jun. 24, 2022, Korean Patent Application No. 10-2022-0077265, filed on Jun. 24, 2022, and Korean Patent Application No. 10-2022-0107472, filed on Aug. 26, 2022, the disclosures of which are incorporated herein by reference in their entirety.

### TECHNICAL FIELD

Disclosed herein is a charger connecting to an energy storage device, and a method of providing a user interface thereof, and in particular, a charger performing a power charge operation based on a power supply situation and providing a user interface related thereto.

BACKGROUND

Energy storage devices (energy storage systems (ESS)) store electricity in their batteries and the like, and then supply the power to a grid. Energy storage devices can perform charge and discharge.

At a time when there is a growing demand for an electric vehicle, a charger for an electric vehicle can be provided in various spaces for charging the electric vehicle. The use of the charger for an electric vehicle results in an increase in the power consumption of the grid and affects the power consumption of another electric component in a corresponding space or the space where the charger is place. In particular, a surge in the power consumption may cause limitations to the use of the charger for an electric vehicle.

To prevent this from happening, a charger enabling reliable charge in the space where the charger is placed, and a use interface for the charger are required.

### SUMMARY

The objective of the present disclosure is that an energy storage device assists with the power consumption of a charger and ensures a reliable power supply of a grid, and that the charger provides a charge service.

The objective of the present disclosure is that an energy storage device assists with the power consumption of a charger depending on a power consumption situation and ensures a reliable power supply of a grid, and the charger provides a charge service.

The objective of the present disclosure is that an energy storage device supplies electric power to a charger if the electric power of a grid is cut or the supply and demand for electric power is unreliable and enables a reliable power supply.

The objective of the present disclosure is that an energy storage device supplies electric power to another region connecting to a grid if the electric power of the grid is cut or the supply and demand for electric power is unreliable and ensures a reliable power supply.

Objectives of the present disclosure are not limited to the objectives described above, and other objectives that are not mentioned above can be clearly understood by one having ordinary skill in the art, based on the following description.

An energy storage device of one embodiment electrically connects to a grid that supplies electric power to the energy storage device, a charger and another load except for the energy storage device and the charger.

A charger of one embodiment comprises a power supply part receiving electric power from any one or more supply source of a grid or an energy storage device, an interface part providing an interface for selecting any one of a charge cost method or a charge period method and an interface for setting a charge cost or a charge period, based on the selected method, a charger controller determining a charging price unit of a charge cost or a charge period depending on the sort of a supply source, and a charge part proceeding with charge based the period or cost selected at the interface part.

A method of providing a user interface of one embodiment in a charge method in which in response to a change in the power supply situation, a charger receives electric power supplied from a power grid and an energy storage device under the control of the energy storage device, based on the switching or merging of power supply, and then charges an object in need of charge by using the supplied electric power, to provide reliable charge. The method comprises displaying a first screen interface for selecting any one of a charge cost method and a charge period method on a screen and receiving a user's input selection by the charger, displaying detailed information on the charge period method or the charge cost method selected through the first screen interface through a second screen interface on a screen and receiving a user's input selection by the charger, and displaying information on a charge state through a third screen interface on a screen as charge proceeds based on the detailed information on the charge period method or the charge cost method selected through the second screen interface by the charger.

In some embodiments of the present disclosure, the energy storage device assists with the power consumption of the charger to stabilize the power supply of the grid, such that the charger provides a reliable charge service.

In some embodiments of the present disclosure, the energy storage device assists with the power consumption of the charger depending on a power consumption situation to stabilize the power supply of the grid such that the charger provides a reliable charge service.

In some embodiments of the present disclosure, the energy storage device supplies electric power to the charger if the electric power of the grid is cut or the supply and demand for electric power is unreliable, to ensure a reliable power supply.

In some embodiments of the present disclosure, the energy storage device supplies electric power to another region connecting to the grid if the electric power of the grid is cut or the supply and demand for electric power is unreliable, to ensure a reliable power supply.

Advantages of the subject matter of the present disclosure are not limited to the advantages described above, and other advantages that are not mentioned above can be clearly understood by one having ordinary skill in the art, based on the following description.

### BRIEF DESCRIPTION OF DRAWINGS

The accompanying drawings constitute a part of the specification, illustrate one or more embodiments in the disclosure, and together with the specification, explain the disclosure, wherein:

FIG. 1 is the configuration in which an energy storage device is disposed in a space and provides electric power to other electric devices according to one embodiment of the present invention.

FIG. 2 is a view showing the configuration in which a charger of one embodiment receives electric power from an energy storage device and a power distributor;

FIG. 3 is a view showing specific operations of the charger according to one embodiment of the present invention.

FIG. 4 is a view showing the configuration in which a charger of another embodiment receives electric power from an energy storage device;

FIG. 5 is a view showing specific operations of an energy storage device according to one embodiment of the present invention.

FIG. 6 is a view showing the configuration of the energy storage device according to one embodiment of the present invention.

FIG. 7 is a view showing the process in which a controller of one embodiment controls an energy storage device depending on the amount of electric power in a grid;

FIG. 8 is a view showing the arrangements and operations of the energy storage device and the charger according to one embodiment of the present invention.

FIG. 9 is a view showing the arrangements and operations of an energy storage device and the charger according to another embodiment of the present invention.

FIG. 10 is a view showing the process in which the energy storage device operates in response to an increase in the power consumption inside a grid according to one embodiment of the present invention.

FIG. 11 is a view showing the configuration of the energy storage device according to another embodiment of the present invention.

FIG. 12 is a view showing the configuration of the charger according to one embodiment of the present invention.

FIGS. 13 is a view showing the process in which the charger of one embodiment displays an interface that is required for charging or charge;

FIGS. 14 is a view showing the process in which the charger of another embodiment displays an interface that is required for charging or charge;

FIG. 15 is a view showing the process of determining a charging price unit according to one embodiment of the present invention.

FIG. 16 is a view showing an interface for selecting a charge method according to one embodiment of the present invention.

FIGS. 17 to 24 are views showing a charge interface according to one embodiment of the present invention.

FIG. 25 is a view showing the process of charge after the charge starts according to one embodiment of the present invention.

FIG. 26 is a view showing an interface for setting a charge amount according to another embodiment of the present invention.

### DETAILED DESCRIPTION

Advantages and features in the present disclosure and methods for ensuring the same can be clearly understood from the embodiments that are described hereafter with reference to the accompanying drawings. The subject matter of the present disclosure, however, can be embodied in various different forms, and should not be construed as being limited to the embodiments set forth herein. Rather, the embodiments are provided as examples so that the present disclosure can be thorough and complete and that the scope of the disclosure can be fully conveyed to one having ordinary skill in the art. The subject matter of the present disclosure is to be defined only according to the scope of the appended claims. Throughout the disclosure, identical reference numerals can denote identical or similar components.

In the disclosure, detailed description of known technologies in relation to the disclosure is omitted if it is deemed to make the gist of the disclosure unnecessarily vague.

The terms first, second, A, B, (a), (b) and the like are used herein only to distinguish one component from another component. Thus, the essence, order, sequence or number and the like of the components should not be limited by the terms. When any one component is described as being “connected”, “coupled”, or “connected” to another component, any one component can be directly connected or coupled to another component, but an additional component can be “interposed” between the two components or the two components can be “connected”, “coupled”, or “connected” by an additional component.

Hereafter, described is a technology for controlling the charge or discharge of an energy storage device installed in a space such as a building or a house, a subway, a public place and the like, based on the situation in which other electric devices in the space consume electric power. Additionally, described is a technology for enabling the energy storage device to control a charger, based on the above-described situation. Further, described is a technology for enabling the energy storage device to provide electric power to the other electric devices at a time when the electrical loads of the other electric devices increase. The embodiments described herein relate to power supply technologies. Power is provided from a power source, such as an electric power supply network (grid), an energy storage system (ESS), etc., to the consumption side. Here, the costs incurred for supplying power can be divided into a basic rate (i.e., contract demand) and a usage rate. Although the usage rate is relatively low, the contract demand is relatively high and thus from the consumer's standpoint, receiving power via contract demand in an effective manner is important. Hereafter, exemplary situations of electric vehicle charging shall be explained, but it can be understood that the features in the present embodiments can be used with respect to various types of objects that require power charging.

In order to lower the contract demand during the electric vehicle charging process, use of an appropriate energy storage system (ESS) and effective control thereof are needed. Such ESS can be connected with a power network (or grid), whereby power for charging an electric vehicle can be primarily received from the grid, and the ESS can act to supplement the grid. In general, an electric vehicle can undergo so-called slow charging, fast charging and super-fast charging, whereby charging at 200 kW or above can be considered to be super-fast charging. In order to support such super-fast charging while lowering the contrast demand, the ESS can be implemented to supply power at various kW levels.

An ESS can have various types of batteries or power cells therein, such as lithium-based batteries, flow batteries, redox batteries, etc. The embodiments herein are explained in an exemplary manner with respect to vanadium-based batteries, which are a type of redox batteries.

Here, the rate of charging (or discharging) a battery is referred to as a “C-rate (C),” which can be defined as an output corresponding to an amount of battery exhaustion during a particular time duration. For example, 1 C-rate (or 1C) can be the battery output upon 1 hour of battery exhaustion. Thus, a fully charged battery rated at 1 Ah should provide 1 A for one hour. As such, the C-rate may indicate the speed of battery charging (or discharging). Also, the C-rate can be the measurement of current in which the battery is charged (or discharged) at.

Consumers currently wish for electric vehicle charging to be performed within about 30 minutes, and an ESS that supports the power grid needs to support this requirement. Conventional lithium batteries only support 1˜2 C-rate, thus there are limitations in supporting super-fast charging for electric vehicles. The vanadium-based batteries under research and development by the present inventors exhibit high C-rate characteristics that exceed such 1˜2 C-rate levels, which is possible due to the electrochemical properties provided by the special constitution of such vanadium-based batteries. Development and commercialization efforts for conventional vanadium flow batteries (VFBs) are being made, but the present inventors have developed vanadium ion batteries (VIBs) that overcome the shortcoming of such VFBs.

Such vanadium ion batteries (VIB) not only have high C-rate characteristics, but also provide wide C-rate coverage which allow for various commercial applications.

In particular, the present inventors realized that their VIBs can be implemented in ESS applications that support electric vehicle power charging, whereby VIBs can be implemented in relatively small-sized ESS equipment and operations that can be installed at urban locations and highly populated regions due to practically no risk of extreme heat, fire or explosive hazards when compared to conventional ESSs having lithium batteries.

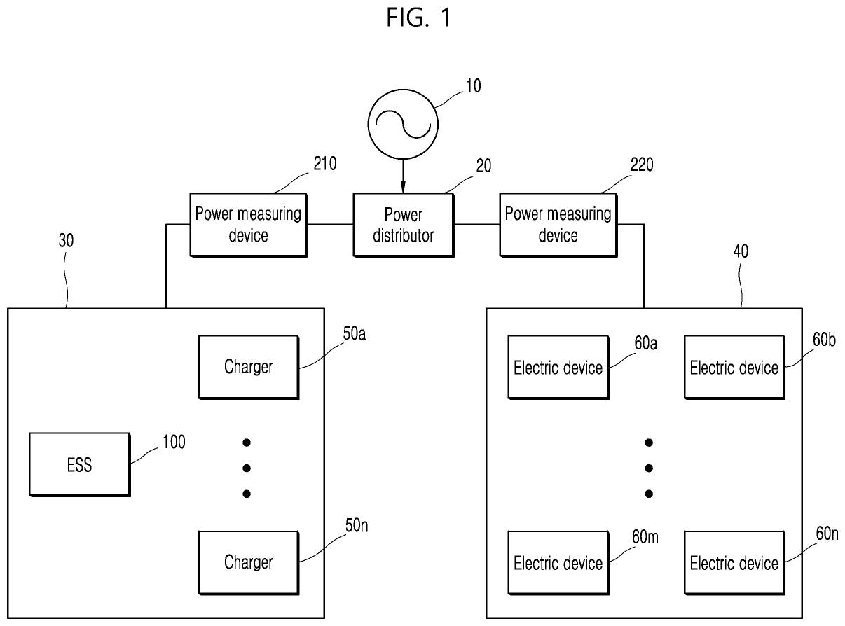

FIG. 1 is the configuration in which an energy storage device (ESS) is disposed in a space and provides electric power to other electric devices according to one embodiment of the present invention. FIG. 1 shows an energy storage device (ESS) 100 providing electric power to a supportive power region 30 and a primary power region 40, and other electric devices (60a, 60b, . . . 60m, 60n). A grid corresponding to a power source 10 may provide electric power to the supportive power region 30 and the primary power region 40. The energy storage device (ESS) 100 may be disposed in the supportive power region 30.

Here, the term “grid” may be interpreted as an electric power system, a power grid, etc. A grid can refer to a power network, which generally has an electric generator, an electric transformer, power lines, and other related equipment or devices, for supplying electric power from an electricity/power generation side to an electricity/power consumption side. The size of a grid may vary greatly. A very large-sized grid may be used to manage or handle an entire continent or country for supplying power thereto. One or more very small-sized grids or multiple regional/area grids can be operated as well. A grid may also have control or management functions that can automatically supply electricity generated from another region to an area that exhibits increased power consumption in order to balance the overall power supply of the grid.

The power amount needed at a power consumption side could be set on a fixed basis from the outset, or the needed power amount could be dynamically changed depending upon the power usage environment, commercial technical areas, application schemes, etc. based on changes in power usage requirements. Thus, various types of management and control devices that are related to the grid can provide the necessary management and control functions for handling such supply power requirements and changes. More details regarding these matters will be explained hereafter in view of the various embodiments.

The power source 10 provides electric power to a corresponding space, and in one embodiment, comprises an AC grid. A predetermined power distributor 20 distributes the electric power provided by the power source 10 to two or more power regions 30, 40.

In one embodiment, the power distributor 20 may provide electric power to the supportive power region 30 and the primary power region 40. The power distributor 20 may be a distribution board, in one embodiment.

The primary power region 40 comprises the region to which electric power is provided by the power source 10, and is separate from the supportive power region 30. The energy storage device of one embodiment may provide electric power to the supportive power region 30 and the primary power region 40, and be disposed in the supportive power region 30.

The energy storage device (ESS) 100 and one or more chargers (50a, . . . , 50n) may be disposed in the supportive power region 30. A plurality of electric devices (60a, . . . , 60n) may be disposed in the primary power region 40. Additionally, an additional ESS may be disposed in the primary power region 40, apart from the energy storage device 100 disposed in the supportive power region 30. That is, an additional ESS that is different from the energy storage device 100 may be disposed as an electric device (e.g., 60m) in the primary power region 40.

In the embodiment of FIG. 1, the power distributor 20 may distribute electric power to the supportive power region 30 and the primary power region 40. A configuration without the power distributor 20 may also be included in the embodiments of the present disclosure. Here, the electric power provided by the power source 10 may be provided to the supportive power region 30 and the primary power region 40 by a single power line. Additionally, the energy storage device 100, and chargers (50a, . . . , 50n) receiving all or part of the electric power from the corresponding energy storage device 100 may be disposed in the supportive power region 30.

The energy storage device (ESS) 100 of one embodiment may provide electric power to the supportive power region 30 and the primary power region 40 within a maximum range of the power source 10's supply of electric power. The energy storage device 100 may perform charge or discharge operations, depending on the demand or expected demand for electric power of the two regions 30, 40.

To this end, a power measuring device 210 may be connected to and disposed near the supportive power region 30. Alternatively, a power measuring device 210 may be disposed within the supportive power region 30.

Further, a power measuring device 220 may be connected to and disposed near the primary power region 40. Alternatively, a power measuring device 220 may be disposed within the primary power region 40.

As the power measuring device 210, 220, an instrument for measuring the amount of electric power (e.g., a power meter) in one embodiment measures the amount of electric power that is being used in the region where the instrument for measuring the amount of electric power is installed. The power measuring device 210, 220 transmits a measured value (e.g., the amount of electric power) to the energy storage device 100.

Additionally, in one embodiment, an additional power measuring device may also be disposed at the power source 10. Here, the energy storage device 100 may check the magnitude of power consumption of the power source 10 in real time, namely, in a dynamic manner.

In another embodiment, the energy storage device 100 may add the power consumption of the power measuring device 210 in the supportive power region 30 and power consumption of the power measuring device 220 in the primary power region 40, which are branched from the power distributor 20, to calculate to a total amount of electric power consumed by the power source 10. The features related to the power measuring devices 210, 220 may vary depending on the implementation and the present invention need not be limited thereto.

Further, the energy storage device 100 may comprise the above-described power measuring device 210 in the supportive power region 30 as an internal component thereof. The energy storage device 100 may receive power consumption in the primary power region 40 from the power measuring device 220 in the primary power region 40, based on a particular communication protocol.

In the present disclosure, the energy storage device comprises an energy storage device that comprises a vanadium ion battery, but need not be limited thereto. For example, the energy storage device according to the present disclosure may comprise a vanadium redox battery (VRB), a polysulfide bromide battery (PSB), a zinc-bromine battery (ZBB) and the like.

In the case of an embodiment of FIG. 1, when a charger 50 charges an electric vehicle or another device in need of charge, the charger 50 may perform a charge operation, under the charge conditions necessary for charging of the electric vehicle or another device. For example, if high current-rate charge is requested, the charger 50 performs high current-rate charge. Based on control of the energy storage device 100, the electric power of the power source 10 and the energy storage device 100 is provided to the charger 50.

Here, a so-called “high current-rate” may refer to a current rate that is relatively much higher than that used for conventional lithium-based batteries. For example, if the normal C-rate of conventional lithium-based batteries is about 0.1-0.25 C, the relatively high C-rate used in accordance with the present embodiments can be in the range of about or above. Here, it should be noted that such C-rate range is merely exemplary, based upon experimental results conducted by the present inventors. As such, the particular C-rate values and ranges applicable for the present embodiments may be different depending upon various conditions.

The energy storage device 100 may control the charger 50 such that electric power is provided only from the power source 10 to the charger 50, depending on the amount of electric power provided by the power source 10 and the amount of electric power consumed in the primary power region 40. Additionally, the energy storage device 100 may provide its electric power only to the charger 50 depending on the amount of electric power provided by the power source 10 and the amount of electric power consumed in the primary power region 40. Alternatively, the energy storage device 100 may provide its electric power as a portion of electric power requested by the charger 50. As a result, the charger 50 may charge an electric vehicle or other devices by using electric power provided from both the power source 10 and the energy storage device 100.

The energy storage device 100 adjusts the amount of electric power to be provided to the charger 50, depending on the situation where the power source 10 provides electric power or the situation where electric power is consumed in the primary power region 40. Accordingly, even if the amount of electric power of the power source changes, the charger 50 may charge an electrical vehicle or other devices in a reliable manner. In particular, when the charger 50 performs high current-rate charge, the energy storage device 100 provides electric power to the charger 50 at a predetermined level or above, depending on the situation where the power source 10 provides electric power or the situation where electric power is consumed in the primary power region 40, such that the charger 50 performs high current-rate charge in a reliable manner.

As the charger 50 performs low current-rate charge, the energy storage device 100 may enable the charger 50 to receive electric power from the power source 10 and to be charged, depending on the situation where the power source 10 provides electric power or the situation where electric power is consumed in the primary power region 40.

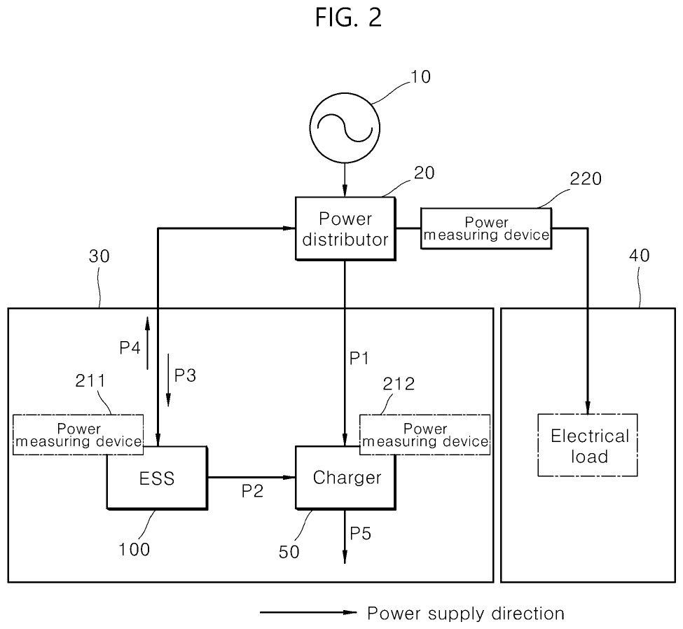

FIG. 2 is a view showing the configuration in which a charger of one embodiment receives electric power from the energy storage device 100 and the power distributor 20. The charger 50 may receive electric power from the power distributor 20 and the energy storage device 100. Specifically, the energy storage device 100 may receive information on the amount of electric power consumed by the charger 50 from a power measuring device 212. The energy storage device 100 may receive information on the amount of electric power consumed in the primary power region 40 from the power measuring device 220.

In the embodiment of FIG. 2, the charger 50 may receive electric power from the power distributor 20 (P1). In one embodiment, the charger 50 may receive electric power from a grid, i.e., the power source 10. Additionally, the energy storage device 100 compares the amount of electric power, received from the power measuring device 210, 220, with a maximum amount of electric power that can be provided by a corresponding the power source 10, to assist with all or part of the amount of electric power to be consumed by the charger 50.

The energy storage device 100 may provide electric power to the charger 50 (P2). The charger 50 may switch or merge electric power that is provided based on the control of the energy storage device 100. The charger 50 may provide electric power based on an external device's request for charge (P5).

The energy storage device 100 may receive electric power from the power distributor 20 (P3). The energy storage device 100 may provide electric power to the primary power region 40 (P4). The electric power provided the energy storage device 100 may be supplied to the primary power region 40 via the power distributor 20. That is, the power supply direction between the energy storage device 100 and the power distributor 20 may be bi-directional.

The power supply (P4) of the energy storage device 100 may be determined based on the demand for electric power in the primary power region 40, a maximum amount of electric power provided by the power source 10, and the like.

Thus, if the amount of electric power of a grid 10, measured by the power measuring device 220, is at a predetermined reference level or below, the energy storage device 100 may perform high current-rate discharge such that the charger 50 performs high current-rate charge. The energy storage device 100 continues to monitor the amount of electric power of the grid 10 during the high current-rate discharge, such that the charger 50 performs high current-rate charge.

As a result, if the power consumption of the grid 10 increases, the energy storage device 100 may stop the high current-rate discharge for the charger 50. Alternatively, the energy storage device 100 may perform high current-rate discharge to assist with high current-rate charge of the charger 50, depending on the situation where energy is stored in the energy storage device 100.

If the energy storage device 100 assists with high-speed charge and discharge of the charger 50, the energy storage device 100 monitors the amount of electric power of the grid 10 to flexibly respond to an electric power situation of the grid 10. In particular, the energy storage device 100 may accumulatively store information on time when the grid 10 uses electric power in the past, and predict a time slot (time interval or period) when the amount of electric power consumed by the grid 10 is small. Thus, the energy storage device 100 may prepare for a rapid increase in the power consumption of the grid during the high-speed charge and discharge of the charger 50.

Further, in the case of high-speed charge of the energy storage device 100, the above-described process may be applied. That is, the energy storage device 100 may receive the electric power of the grid 10 and perform its high-speed charge. During this process, the energy storage device 100 may monitor the amount of electric power of the grid 10 to flexibly respond to an electric power situation of the grid 10, as described above.

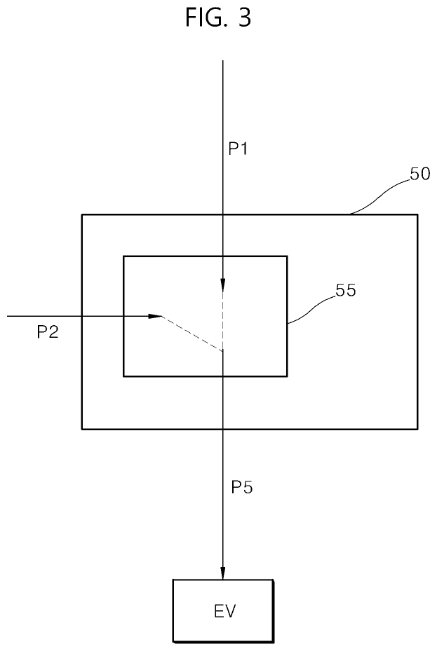

FIG. 3 is a view showing specific operations of the charger according to one embodiment of the present invention.

The charger 50 may receive electric power from two power supply lines P2, P1. The charger 50 may comprise a component 55 that provides a merging/switching function. If electric power is not provided through P2, the charger 50 may provide a charge service to an external device (e.g., an electric vehicle (EV)) by using electric power provided from Pl.

Additionally, if electric power is provided through P2, the charger 50 may provide a charge service to an external device (EV) by using electric power provided from both of P1 and P2. At this time, the amount of electric power that is used by the charger through P1 is less than the amount of electric power that is provided only through P1.

Further, the charger 50 may provide a charge service to an external device (EV) by receiving electric power only through P2. At this time, the amount of electric power that is used by the charger 50 through P1 is 0.

The energy storage device 100 may control the operation of the charger 50. At this time, that charger 50 may determine the amount of electric power to be used through P1 and P2, based on the control of the energy storage device 100. Alternatively, the charger 50 may adjust the amount of electric power that is used through P1, depending on the amount of electric power provided from P2. The energy storage device 100 may control the charger 50 by increasing and decreasing the amount of electric power provided to the charger 50 such that the charger 50 adjusts the amount of electric power which is used through P1.

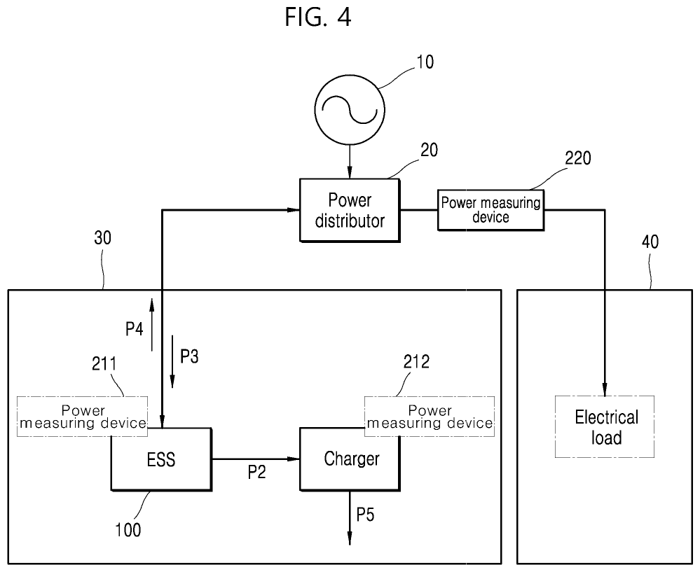

FIG. 4 is a view showing the configuration in which a charger of another embodiment receives electric power from the energy storage device. The charger 50 may receive electric power from the energy storage device 100. Specifically, the energy storage device 100 may receive information on the amount of electric power used by the charger 50 from the power measuring device 212. The energy storage device 100 may receive information on the amount of electric power used in the primary power region 40 from the power measuring device 220.

In the embodiment of FIG. 4, the charger 50 may receive electric power from the energy storage device 100, and the energy storage device 100 may provide electric power charged in the battery therein or provide electric power supplied from the power distributor 20 to the charger 50 by delivering the same (P2). Alternately, the energy storage device 100 may adjust the amount of supplied electric power and the amount of delivered electric power out of electric power supplied from the power distributor 20.

The process of adjusting of a power supply ratio is described specifically. The energy storage device 100 may compare the amount of electric power to be used by the charger 50, the amount of electric power used in the primary power region 40, and a maximum amount of electric power provided by a corresponding the power source 10 and the energy storage device 100 may assist with all or part of the amount of electric power to be used by the charger 50. The energy storage device 100 may provide the electric power charged in the battery to the charger 50 (P2). The charger 50 may provide electric power based on an external device's request for charge (P5).

The energy storage device 100 may receive electric power from the power distributor 20 (P3). The energy storage device 100 may provide electric power to the primary power region 40 (P4). The electric power provided by the energy storage device 100 is supplied to the primary power region 40 via the power distributor 20. That is, the power supply direction between the energy storage device 100 and the power distributor may be bi-directional.

The power supply (P4) of the energy storage device 100 may be determined based on the demand for electric power in the primary power region 40, a maximum amount of electric power of the power source 10, and the like.

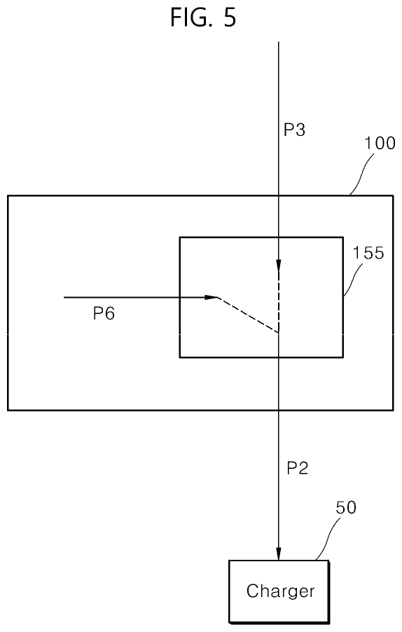

FIG. 5 is a view showing specific operations of an ESS of one embodiment.

The energy storage device 100 may supply the electric power (P3) provided by the power distributor 20, and the electric power (P6) charged in the battery inside the energy storage device 100 to the charger 50 (P2). The energy storage device 100 may comprise a component 155 that performs a merging/switching function. The energy storage device 100 may supply the electric power provided through P3 to the charger 50 if the energy storage device 100 compares the amount of electric power that is required by the charger 50, the amount of electric power that is used in the primary power region and a maximum amount of electric power that can be supplied by the power source and ascertains that the supply of electric power and the demand for electric power are reliable.

Additionally, the energy storage device 100 may supply a portion of the electric power provided through P3 to the charger 50 as a portion of electric power required by the charger 50, and supply the electric power charged in the battery therein to the charger through P6 as the remaining portion of the electric power required by the charger 50, if the supply of electric power and the demand for electric power are unreliable during the above-described comparison.

Further, the energy storage device 100 may supply the electric power charged in the battery therein to the charger 50 if the supply of electric power through P3 is impossible during the above-described comparison (P6).

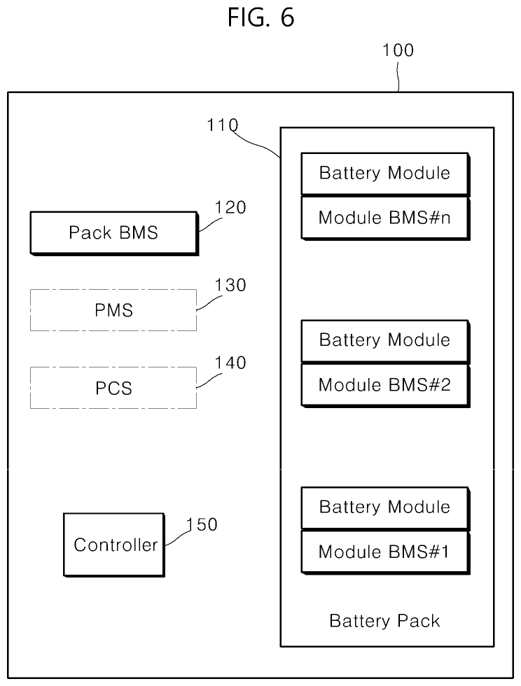

FIG. 6 is a view showing the configuration of the ESS according to one embodiment of the present invention. The energy storage device 100 comprises an energy storage module 110 comprising a battery, and a controller 150.

The controller 150 may determine the charge or discharge of the energy storage module by using results of the measurement of the amount of electric power in the supportive power region and results of the measurement of the amount of electric power in the primary power region. Additionally, the controller 150 may determine whether to discharge electric power to one or more chargers disposed in the supportive power region or to the primary power region.

The energy storage device 100 comprises a Pack BMS 120 that manages the charge and discharge of the energy storage module 110. The energy storage device 100 may selectively comprise a power management system (PMS) 130, and a power conversion system (PCS) 140. An energy storage device 100 comprising both the PMS 130 and the PCS 140 may be referred to as an integrated ESS.

Alternatively, depending on the configuration of the energy storage device 100, the PMS 130 and the PCS 140 may be configured as an additional device, physically apart from the energy storage device 100. The PMS 130 and the PCS 140 may operate independently as an additional device, and exchange information with the energy storage device 100 based on their communication with the energy storage device 100 to control the operation of the energy storage device 100.

The energy storage module 110 of the energy storage device 100, as illustrated, may be comprised of one or more battery modules and module BMSs that manage corresponding the battery modules. In an example, the energy storage module 110 comprises a battery pack comprised of one or more sets of a battery module-a module BMS.

A battery of the energy storage module 110 may be charged with electricity via the PCS 140. The PCS 140 may be supplied with electricity and stores the same in the battery or discharges electricity to the grid. In this process, the PCS 140 may perform the AC/DC conversion or drawn/discharged voltage or frequency and the like.

The PMS 130 exchanges information with the PCS 140 based its communication with the PCS 140 to provide information required for the charge or discharge or control of the battery to the PCS 140.

The module BMS monitors the charge state, discharge state, temperature, voltage, current and the like of each battery and manages the battery. The pack BMS is a battery management system for the entire battery packs.

The controller 150 may determine whether to charge the energy storage module 110 or discharge the electricity of the energy storage module 110 by using results of the measurement of the amount of electric power in the supportive power region and results of the measurement of the amount of electric power in the primary power region. Or, the controller 150 may determine whether to discharge electricity to one or more chargers in the supportive power region or to the primary power region. Further, in one embodiment, the controller 150 may be integrated with the PMS 130 to operate as one component.

In one embodiment, the controller 150 may be an independent component. In another embodiment, the controller 150 may be embodied in the PMS 130, and the PMS may provide the function of a controller that is described in the present disclosure.

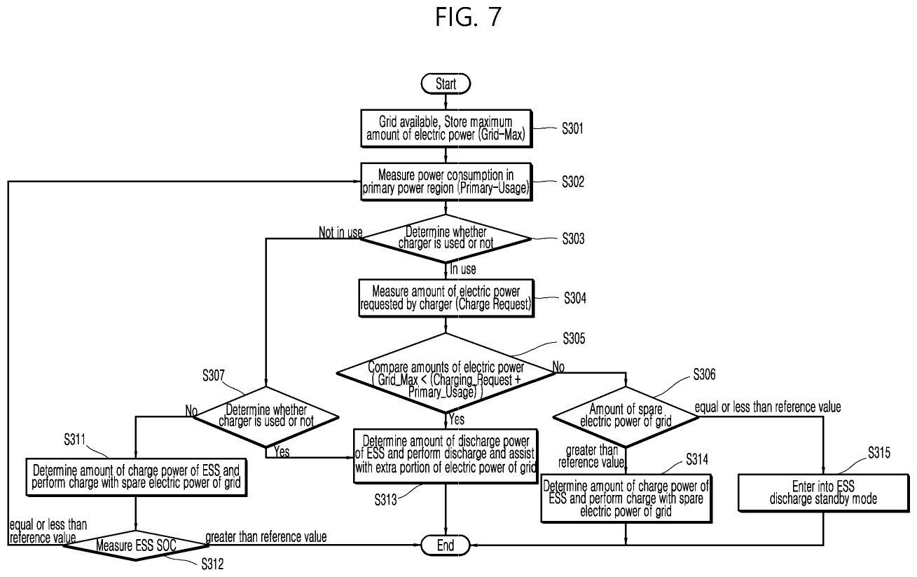

FIG. 7 is a view showing the process in which a controller of one embodiment controls an ESS depending on the amount of electric power in a grid.

The controller 150 may store a grid supplying electric power to the primary power region and the supportive power region, i.e., a maximum amount of electric power (Grid_Max) of the power source 10 (S301). The maximum amount of electric power (Grid_Max) denotes a maximum amount of electric power that can be used in the grid. The above-described power source 10 may provide information of a maximum amount of electric power to the controller 150. Alternatively, a maximum amount of electric power of the power source 10 may be input to the controller 150 previously. The maximum amount of electric power may increase or decrease depending on a later power supply situation, and depending on an increase or decrease in the maximum amount of electric power, the controller 150 may update information on the input maximum amount of electric power.

Then the power measuring device 220 measures power consumption (Primary_Usage) in the primary power region 40 (S302). In one embodiment, the power measuring device 220 measures power consumption (the amount of load usage) in an area except for the supportive power region 30 where the energy storage device 100 is disposed. The energy stage system 100 may receive the power consumption (Primary_Usage) in the primary power region 40 from the power measuring device 220 disposed in the primary power region 40, based on a predetermined communication protocol.

In another embodiment, in step 302, the energy storage device 100 or the controller 150 may receive the entire power consumption of the grid or the power consumption in the primary power region. For example, an additional power measuring device may be disposed between the power source 10 and the power distributor 20, in FIG. 1. The controller 150 may receive the entire power consumption of the grid from the power measuring device disposed between the power source 10 and the power distributor 20 to monitor a power consumption situation of the grid.

Then the controller 150 may determine whether the charger 50 disposed in the supportive power region 30 (S303) is used. If a plurality of chargers 50 is provided, the controller 150 may determine whether each of the plurality of chargers 50 is used. If the charger 50 is not being used, the controller 150 performs step 307. When comparing the amounts of electric power (S307), the controller 150 compares the Grid_Max and the Primary_Usage. If the Grid_Max is the Primary_Usage or greater, the controller 150 determines the charge amount of the ESS and charges the ESS (S311).

Additionally, the controller 150 may measure the state of charge (SoC) of the ESS (S312), and if the measured SoC is an SoC reference value or greater, the controller 150 may stop the charge of the ESS. The controller 150 may measure the SoC of the energy storage device 100 (S312), and if the measured SoC is the SoC reference value or less, the controller 150 may control the charge of the ESS by repeating steps following step 302.

Further, if the Grid_Max is less than the Primary_Usage in step 307, the controller 150 determines the amount of discharge power of the energy storage device 100 and controls the energy storage device 100 such that the energy storage device 100 discharges electricity to the primary power region 40 (S313). Thus, amount of excess over the electric power of the grid will be provided from the discharge of the energy storage device 100.

If the charger is being used in step 303, the controller 150 measures the amount of electric power requested by the charger (Charge_Request) (S304). At this time, suppose that the SoC of the ESS is the reference value or greater. When comparing the amounts of electric power (S305), the controller 150 compares a total of the Charge_Request and the Primary_Usage (Charge_Request+Primary_Usage) and the Grid_Max.

If the Grid_Max is less than (Primary_Usage+Charge_Request) as a result of the comparison, the controller 150 determines the amount of discharge power of the energy storage device 100 and controls the energy storage device 100 such that the energy storage device 100 discharges electricity to the primary power region 40 (S313). Thus, amount of excess over the electric power of the grid will be provided from the discharge of the energy storage device 100.

Further, if the Grid_Max is the (Primary_Usage+Charge_Request) or greater as a result of the comparison in step 305, the controller 150 ascertains whether the difference (the amount of spare electric power of the grid; see formula 1 described hereafter) is a grid spare reference value or greater (S306).

Spare electric power of grid=Grid_Max−(Primary_Usage+Charge_Request) [Formula 1]

If the amount of spare electric power of the grid is the grid spare reference value or greater, it means a sufficient amount of electric power. Accordingly, the controller 150 determines the amount of charge power of the energy storage device 100 and controls the energy storage device 100 such that the energy storage device 100 is charged (S314). At this time, the energy storage device 100 is charged with a sufficient amount of spare electric power of the grid.

On the contrary, if the amount of spare electric power of the grid is less than the grid spare reference value, it is less likely that later, the amount of electric power of the grid satisfies the demand for electric power in the supportive power region 30 and the primary power region 40. Thus, the controller 150 puts the energy storage device 100 into a discharge standby mode (S315).

In the step (S311, 5314) of the charge of the ESS of FIG. 7, the controller 150 may perform high current-rate charge of the battery. Additionally, the controller 150 continues to receive results of the measurement of the amount of electric power in the primary power region, and if the spare electric power of the grid decreases, performs low current-rate charge of the battery or puts the energy storage device 100 into a discharge standby mode, as described in step 315. Certainly, in a discharge standby mode, the controller 150 monitors the entire electric power situation of the grid and the SoC of the battery to determine the low power charge or high current-rate charge of the battery.

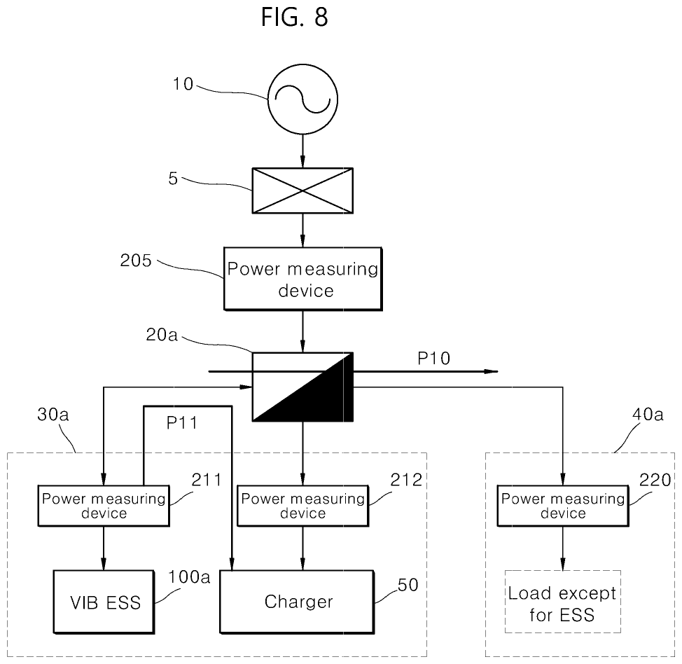

FIG. 8 is a view showing the arrangements and operations of the ESS and the charger according to one embodiment of the present invention. FIG. 8 shows a vanadium ion battery ESS (VIB ESS) 100a is disposed as an example of the ESS. The supply of electricity is performed in the order of the power source 10 that is a grid, a transformer substation 5, a power measuring device 205 and a power distributor 20a (e.g., a main panel board). Electricity is supplied from the power distributor 20a to the VIB ESS 100a, the charger 50 and loads other than the ESS. The power measuring device 205 is disposed at a grid main power line, and power measuring devices 211, 212, 220 may be disposed for each line in each region 30a, 40a. Information on power consumption in each region and information on entire power consumption are transmitted to the VIB ESS 100a.

The supportive power region 30a and the primary power region 40a that are described above distinguish from each other. Each of the power measuring devices 211, 212, 220 may measure the consumption of electric power branched from the power distributor 20a. Additionally, the controller disposed in the VIB ESS 100a may receive information on the consumption of electric power, which is measured by each of the power measuring devices. At this time, the VIB ESS 100a may comprise a PMS, and the PMS may serve as the controller.

As described with reference to FIG. 7, the VIB ESS 100a stores information on a maximum amount of electric power (Grid_Max) that can be used in the grid. Additionally, the VIB ESS 100a may receive information on the amount of electric power supplied to a load except for the ESS (e.g., the amount of electric power being used in from the power measuring device 220 disposed in 40a. Further, in one embodiment, the VIB ESS 100a may receive the entire power consumption of the grid (Grid_Usage) from the power measuring device 205.

The VIB ESS 100a may receive the Grid_Usage on a regular basis or in real time. The cycle of the regular reception may change depending on a change in the power consumption in the primary power region 40a. For example, the controller 150 may set the reception cycle to 5 minutes when there is almost no change in the power consumption, i.e., at night, and set the reception cycle to 1 minute when there is a big change in the power consumption, i.e., during the day.

The VIB ESS 100a may control its charge or discharge to optimize the use of power of the grid, depending on the power consumption in the primary power region 40a.

The driving mode of the VIB ESS 100a comprises a charge mode, a discharge mode and a standby mode. In the charge mode, the VIB ESS 100a determines the charge amount of the ESS, and based on the SoC reference value of the ESS, performs charge and then ends the charge mode.

In the discharge mode, the VIB ESS 100a receives information on the amount of electric power requested by the charger 50 (Charge_Request) from the power measuring device 212, and compares a total of the amount of electric power (Primary_Usage) received from the power measuring device 220 in the primary power region 40a and the amount of electric power requested by the charger 50 (Charge_Request) with the Grid_Max to determine whether to discharge electricity. The determination process is described above with reference to FIG. 7.

Additionally, if the Primary_Usage is the Grid_Max or greater or the electric power of the grid is cut, the VIB ESS 100a may discharge electricity charged to the primary power region 40a. For example, if the VIB ESS 100a discharges electricity to the power distributor 20a as with P10, the power distributor 20a may supply the discharged electricity to the primary power region 40a.

Further, the VIB ESS 100a may assist with all or part of the electric power output from the charger 50 (P11). For example, if a value (the amount of available electric power) calculated by deducting the power consumption in the primary power region 40a from the maximum amount of electric power of the grid is less than the amount of electric power output from the charger 50 (the occurrence of a shortage of charge power of the charger), the VIB ESS 100a may assist with a shortage amount or more of the charge power.

In the discharge mode, the VIB ESS 100a may receive the entire power consumption of the grid from the power measuring device 205.

For example, the VIB ESS 100a receives information on the amount of electric power requested by the charger 50 (Charge_Request) from the power measuring device 212. Additionally, the VIB ESS 100a receives information on the entire power consumption of the grid (Grid_Usage) from the power measuring device 205, and compares a total of the entire power consumption of the grid (Grid_Usage) and the amount of electric power requested by the charger 50 (Charge_Request) with the Grid_Max to determine whether to discharge electricity. The determination process is described above with reference to FIG. 7.

Further, if the electric power of the grid is cut since the Grid_Usage is the Grid_Max or greater, the VIB ESS 100a may discharge electricity having charged the primary power region 40a. For example, if the VIB ESS 100a discharges electricity to the power distributor 20a as with P10, the power distributor 20a may supply the discharged electricity to the primary power region 40a.

Further, the VIB ESS 100a may assist with all or part of the electric power output from the charger 50 (P11). For example, if a value (the amount of available electric power) calculated by deducting the entire power consumption of the grid (Grid_Usage) from the maximum amount of electric power of the grid is less than the amount of electric power output from the charger 50 (the occurrence of a shortage of charge power of the charger), the VIB ESS 100a may assist with a shortage amount or more of the charge power.

In the embodiment of FIG. 8, the VIB ESS 100a may remain in the standby mode. If the SoC of the VIB ESS 100a is the reference value or greater, the VIB ESS 100a may monitor power consumption in the grid without an additional charge process. Further, if the SoC of the VIB ESS 100a is less than the reference value, the VIB ESS 100a may determine a charge amount depending on a current amount of electric power of the grid and proceed with charge. Certainly, if the VIB ESS 100a is in the standby mode, in the SoC that is the reference value or greater, the VIB ESS 100a may supply electric power to the primary power region 40a (P10) or the charger 50 (P11), as the amount of electric power in the grid increases.

In the embodiment of FIG. 8, the VIB ESS 100a may optimize the amount of electric amount of the grid depending on the power consumption situation in the grid. For example, the VIB ESS 100a may assist with the amount of electric power, to minimize a loss caused by over peak power and suppress the overload of the grid.

Since along with the grid, the VIB ESS 100a supplies electric power to the primary power region 40a and the charger 50 under predetermined circumstances, a reliable power supply may be ensured. Additionally, the VIB ESS 100a receives the power consumption of each component and calculates the amount of power lack and assist with the power supply of the grid. For example, if the output of the grid is 100, but the output of the charger is sensed as 95, the VIB ESS (100a) may assist by 5.

In this embodiment, the VIB ESS 100a may provide efficient implementation. For example, a battery, which has an effect on heat and the lifespan at high output, has limitations in assisting with the grid. On the contrary, the VIB ensures a reliable high output. Further, unlike an ESS comprising a battery that has limitations in charge and discharge, the VIB ESS 100a ensures the control of an input and output flow with a high output. Further, the VIB ESS 100a may assist with both the grid and the charger with a high output at a time of power failure of the grid. In particular, despite an instant power failure or a power cut, the VIB ESS 100a may ensure a high output and ensure a reliable power supply for grid.

Furthermore, the VIB ESS 100a may be charged at a high current rate (C-Rate) if the power consumption in the grid is low (there is spare electric power) such that the efficiency in the use of electric power of the grid improves.

Thus, the controller 150 of the VIB ESS 100a may receive results of the measurement of the amount of electric power in the primary power region, and then determine any one of the high current-rate charge or low current-rate charge of the battery. If the amount of electric power in the primary power region is a predetermined reference value or less (e.g., 80% or less) as a result of comparison between the amount of the electric power in the primary power region with the entire power consumption of the grid, the VIB ESS 110 may be charged rapidly based on the high current-rate charge.

If the amount of electric power in the primary power region is greater than the predetermined reference value (e.g., greater than 80%) as a result of comparison between the amount of the electric power in the primary power region with the entire power consumption of the grid, the VIB ESS 100a may continue to be charged based on the low current-rate charge to lower the load of the entire grid. And the VIB ESS 100a may assist with the electric power of the grid with electric power that charges during low current-rate later.

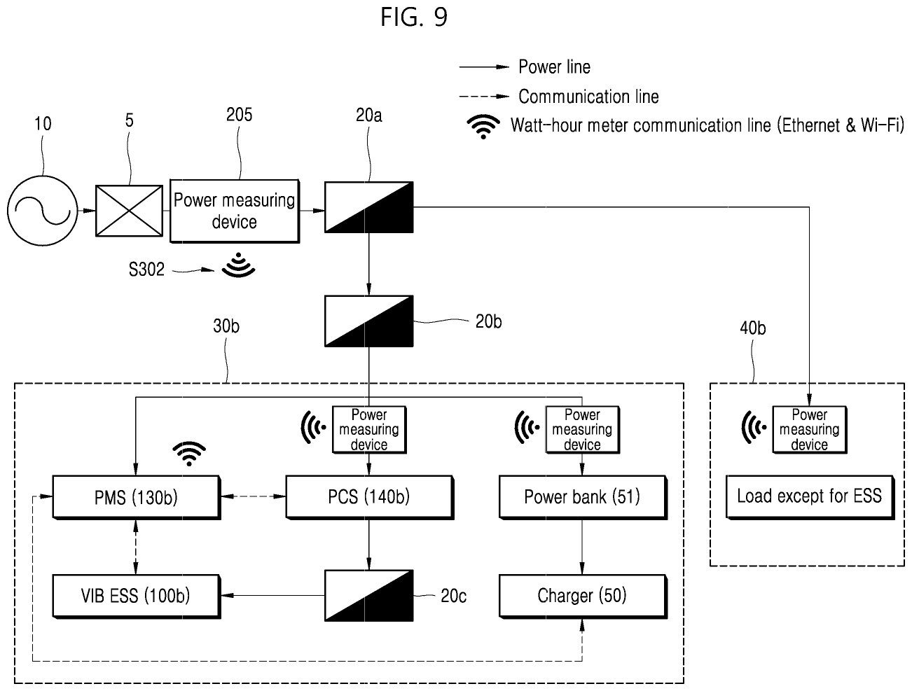

FIG. 9 is a view showing the arrangements and operations of an ESS and the charger according to another embodiment of the present invention. The configuration of FIG. 9 differs from the configuration of FIG. 8 in that a power distributor 20a serving as a main panel board distinguishes from a power distributor 20b serving as an ESS panel board. Additionally, in the configuration of FIG. 9, a power distributor 20c serving as a DC panel board (a container) that supplies electric power to the VIB ESS 100b is additionally provided.

The power distributor 20c may be divided into one or more, and the configuration of the power distributor in the present disclosure is not limited to the configuration of a specific power distributor. The power distributor 20c may be selectively disposed depending on the configuration, arrangement and the like of the VIB ESS 100b.

FIG. 9 shows a PMS 130b and a PCS 140b in a separate manner. However, the arrangement of the PMS 130b and the PCS 140b is not limited. The PMS 130b and the PCS 140b may be arranged in the VIB ESS 100b. The PMS 130b may be integrated with the above-described controller 150 to control a driving mode such as charging or discharging and the like of the VIB ESS 100b.

Further, a power bank 51 may also be a component of the charger 50 or a component independent from the charger 50, depending on the method of embodying the subject matter of the present disclosure. In the configuration of FIG. 9, the VIB ESS 100b may assist with the electric power of the entire grid. The VIB ESS 100b stores information on a maximum output of the power grid. Additionally, the VIB ESS 100b may receive the power consumption of the entire grid from the power measuring device 205. Alternatively, the VIB ESS 100b may receive measurements of the usage of a load except for the ESS to determine the amount of electric power that can be used by the grid. The VIB ESS 100b may receive information on the entire power consumption of the grid or measurements of the use of a load except for the ESS to control its charge or discharge.

The load except for the ESS indicates the load of power consumption except for the VIB ESS 100b and the charger 50, and denotes a load in the primary power region 40b, such as power consumption in a building, power consumption in a house, a server, a subway and the like.

Information on a maximum amount of electric power of the grid may be input to the VIB ESS 100b previously. If the maximum amount of electric power of the grid changes, the VIB ESS 100b stores the changed value. The input value may be stored in the ESS 100b and maintained for a certain period. The VIB ESS 100b may store the information on a maximum amount of electric power of the grid (Grid_Max), at 380V, in AC/150 KW and the like.

In the embodiment of FIG. 9, the grid such as a power source 10 supplies electric power to the energy storage device 100b, the charger 50 and another load (a load except for the ESS) except for the energy storage device and the charger. Additionally, the energy storage device 100b may comprise one or more power measuring devices 205, 211, 212, 220 that measure the amount of electric power of the grid, the energy storage device 100b, the charger 50 and another load (a load except for the ESS).

Further, the controller of the energy storage device 100b determines the charge or discharge of the energy storage module by using any one or more of the amount of electric power of the grid or the amount of electric power of another load, which are measured by the power measuring device 205, 211, 212, 220 or determine the supply of electric power to the charger or another load.

If the amount of electric power of another load (a load except for the ESS) is used to check the amount of electric power of the grid, the energy storage device 100b may determine the charge or discharge of the energy storage module by using a value measured by the power measuring device 220 that is disposed at a load except for the ESS, or determine the supply of electric power to the charger or another load.

Further, if the amount of electric power of another load cannot be used to check the amount of electric power of the grid or the amount of electric power of the grid needs to be checked in real time without an error, the energy storage device 100b may determine the charge or discharge of the energy storage module by using a value measured by the power measuring device 205 that is disposed at the power source 10, or determine the supply of electric power to the charger or another load.

In the embodiment of the present disclosure, when the grid's power supply is reliable, the charge of the ESS may proceed. On the contrary, when the grid's power supply is unreliable, the ESS may supply electric power into the primary power region or the supportive power region 30b.

The energy storage device of one embodiment comprises an energy storage module that comprise a battery, and one or more of energy measuring devices measuring any one or more of the amounts of electric power of the grid, energy storage device, a charger and another load, and a controller determining the charge or discharge of the energy storage module by using any one or more of the amount of electric power of the grid or the amount of electric power of another load that is measured by the power measuring device or determining the supply of electric power to the charger or another load.

A method of controlling an energy storage device in one embodiment comprises receiving information on a maximum amount of output electric power of the grid by the controller of the energy storage device, measuring any one or more of the amounts of electric power of the grid, the energy storage device, the charger and another load by the power measuring device of the energy storage device, determining the charge or discharge of the energy storage module of the energy storage device by using any one or more of the amount of electric power of the grid or the amount of electric power of another load, measured by the power measuring device, or determining the supply of electric power to the charger or another load by the controller.

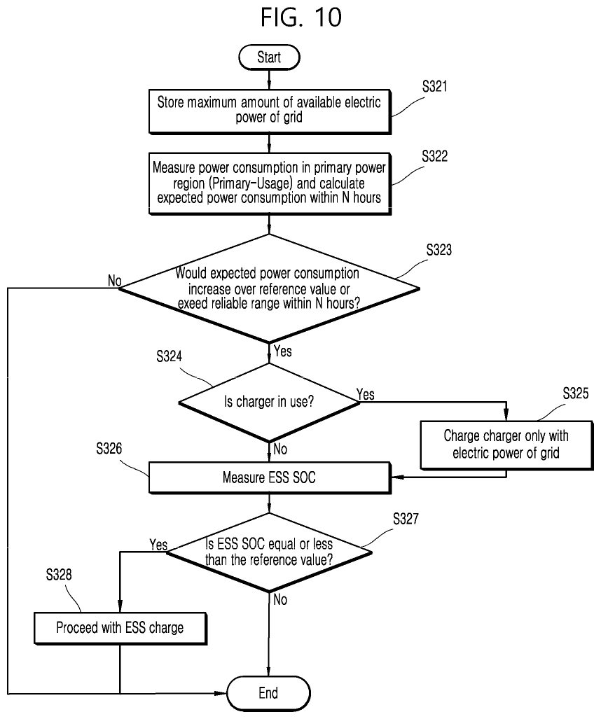

FIG. 10 is a view showing the process in which the ESS operates in response to an increase in the power consumption inside the grid according to one embodiment of the present invention. The controller 150 may calculate expected power consumption in the primary power region to determine a discharge standby mode for the discharge of electricity to any one or more of the primary power region or the charger.

The controller 150 stores a maximum amount of available electric power (Grid_Max) that can be used by the grid (S321). The above-described power source 10 may supply information on the maximum amount of electric power to the controller 150. Alternatively, the maximum amount of electric power of the power source 10 may be input to the controller 150 previously.

Then the power measuring device 220 measures power consumption in the primary power region (Primary_Usage), and the controller 150 calculates expected power consumption within N time (S322). The controller 150 may store information on the power consumption in the primary power region (Primary_Usage) accumulatively. The controller 150 may monitor the power consumption in the primary power region (Primary_Usage) in real time, and if the power consumption increases, calculate expected power consumption within N hours (this time period can be implemented as K minutes or M seconds).

At this time, the controller 150 may calculate the expected power consumption considering a seasonal factor. In one embodiment, the controller 150 may calculate the expected power consumption, based on information on time slots, e.g., 2-4 pm and the like, when an air conditioner is highly likely to be used in a corresponding space (a building, a house and the like).

As a result, the controller 150 may determine whether the expected power consumption is outside a reliable range or greater than a reference value within N ours although current power consumption in the primary power region (Primary_Usage) is in a reliable range or the reference value or less (S323). At this time, the controller 150 proceeds with a standby mode in which the ESS may assist with the power consumption in the primary power region (Primary_Usage) in preparation for an increase in the power consumption.

The controller 150 checks whether the charger 50 is being used (S324). If the charger 50 is being used, the controller 150 may control the charger 50 to proceed with charge only by using the electric power of the grid (S325). Thus, the electric power charged the energy storage device 100 is preserved to assist with the power consumption in the primary power region.

Further, if the charger 50 is not being used or the charger 50 proceeds with charge only by using the electric power of the grid, the controller 150 measures the SoC of the energy storage device 100 (S326). If the SoC of the energy storage device 100 is a reference value or less (S327) as a result of the measurement, charging of the energy storage device 100 is in process (S328).

If the power consumption in the primary power region (Primary_Usage) increases in the process of FIG. 10, the energy storage device 100 may assist with electric power.

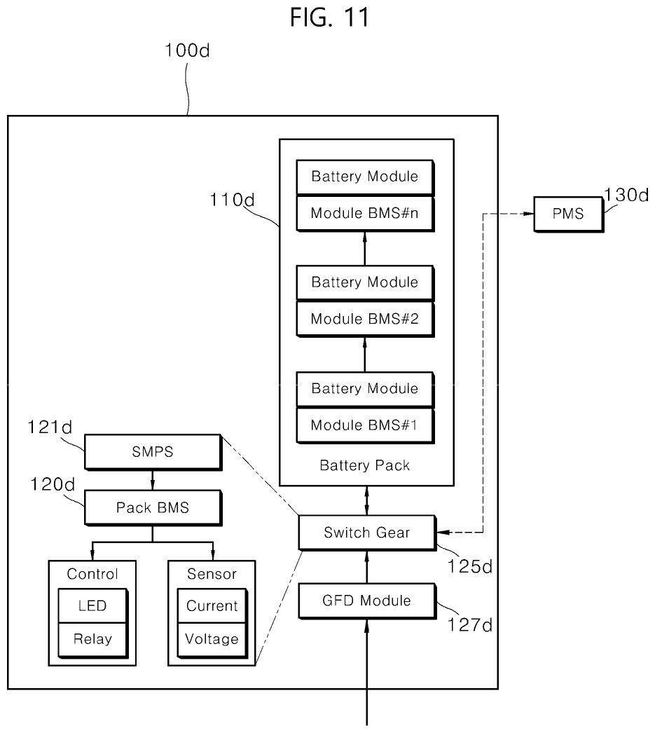

FIG. 11 is a view showing the configuration of an ESS of another embodiment. The electric power supplied from the outside is supplied to a battery pack 110d via a ground fault device (GFD) 127d and a switch gear 125d. A switched-mode power supply (SMPS) 121d and a pack BMS 120d may be detailed components of the switch gear 125d, in one embodiment.

The pack BMS 120d may perform control 128d and sensing 129d, and control an LED and a relay and sense voltage and current.

In FIG. 11, the switch gear 125d and the PMS 130d may constitute the controller 150.

In the above-described embodiment, a power supply network comprises two or more of power supply sources comprising a power grid and at least one of energy storage systems (an energy storage device).

The energy storage system (ESS) 100 receives a request for power charge from a power charger 50 that is used for the charge of an object having a chargeable battery.

The energy storage system 100 compares a total of the amount of electric power requested by the charger (Charge Request) 50 and the amount of electric power defined for primary usage (Primary_Usage) with a maximum amount of electric power that can be used in the power grid (Grid_Max).

If the maximum amount of electric power that can be used in the power grid (Grid_Max) is the total or less, the energy storage system 100 may perform a first procedure, and if not, may perform a second procedure.

The energy storage system 100 may perform the first procedure or the second procedure selectively, such that the power grid or the energy storage system 100 solely supplies electric power to the power charger or the power grid and the energy storage system supply electric power to the power charger together.

Herein, the amount of electric power defined for primary usage (Primary_Usage) relates to the amount of electric power that is used in the primary power region 40 of the power grid. That is, the amount of electric power defined for primary usage (Primary_Usage) comprises a load of a building and the like.

At the first procedure, the energy storage system 100 determines the amount of discharge power of the energy storage system and discharges electricity for assisting with an extra amount of the maximum amount of electric power that can be used in the power grid (Grid_Max), in one embodiment.

At the second procedure, the energy storage system 100 determines the amount of charge power of the energy storage system and performs charge using the spare electric power of the power grid, if the amount of spare electric power of the power grid is a reference value or greater. And, if the amount of spare electric power of the power grid is the reference value or less, then the energy storage system 100 goes into a discharge standby mode, in one embodiment.

The charger 50 supplies electric power to an electric vehicle and charges a battery provided in the electric vehicle. Depending on various above-described power supply situations, the charger 50 may receive electric power from the grid (the power source) 10 or from the ESS 100. Alternatively, the charger 50 may receive electric power from both the grid (the power source) 10 and the ESS 100.

Additionally, the charging for electricity depends on the source of electric power, for example, the source may be the power source 10, the charger 50 itself or the energy storage system 100. For example, the charging price unit per kwh, which is used if the charger 50 receives electric power from the power source 10 to charge an electric vehicle, may differ from the charging price unit per kwh, which is used if the charger 50 uses its electric power to charge an electric vehicle. The charger 50 may use its electric power for charging based on inner battery or supplied power from the energy storage system 100. In addition, the charging price unit may vary depending on a charge period, or the speed of charge such as high-speed charge/low-speed charge and the like.

Accordingly, the charger 50 may provide different charging systems, based on the source of electric power for charge, the speed of charge, a charge method, a charge period and the like, and provide a charging and charge interface that can be easily checked by the user.

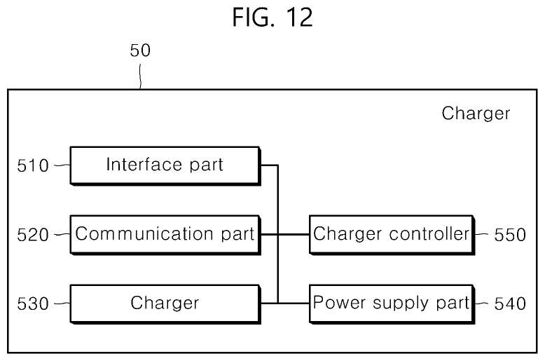

FIG. 12 is a view showing the configuration of the charger of one embodiment.

A charger controller 550 controls the operation of the charger 50 and controls various types of components 510, 520, 530, 540 constituting the charger 50.

An interface part 510 provides an interface that allows the user to input or check information while the charger 50 charges various types of devices such as an electric vehicle, an electric bike and the like. The interface part 510 may be comprised of a touch screen, a button and the like.

A communication part 520 receives information from an external device and transmits information to an external device. The communication part 520 may receive information on a current situation of available electric power, information on whether electric power is input from the grid or the ESS, and the like, from the ESS 100 or the PMS 130 and the like. Additionally, the communication part 520 may transmit information on the situation where the charger 50 is performing charge currently to the ESS 100 or the PMS 130 and the like. Alternatively, the communication part 520 may transmit information on the situation where the charger 50 is performing charge currently to another charger.

A charge part 530 charges another device (an electric vehicle, an electric bike, an electronic product, and the like). A power supply part 540 receives electric power from the outside and supplies the electric power to the charge part 530.

The charger controller 550 outputs a cost, a period, an option and the like in relation to charge to the interface part 510, depending on the source of electric power provided to the power supply part 540. The charger controller 550 may control the charge part 530, based on the source of electric power provided to the power supply part 540, a charge option set at the interface part 510, and the like.

In summary, the power supply part 540 receives electric power from any one or more of the supply sources including the grid and the energy storage device. The interface part 510 provides an interface that can select any one of the charge cost method or the charge period method, and an interface that sets a charge cost or a charge period depending on the selected method.

The charger controller 550 determines the charging price unit of the charge cost or the charge period depending on the sort of a supply source. The charging price unit is billing unit for charging or price unit for charging in predefined amount. The charge part 530 performs charge based on the period or cost selected at the interface part 510.

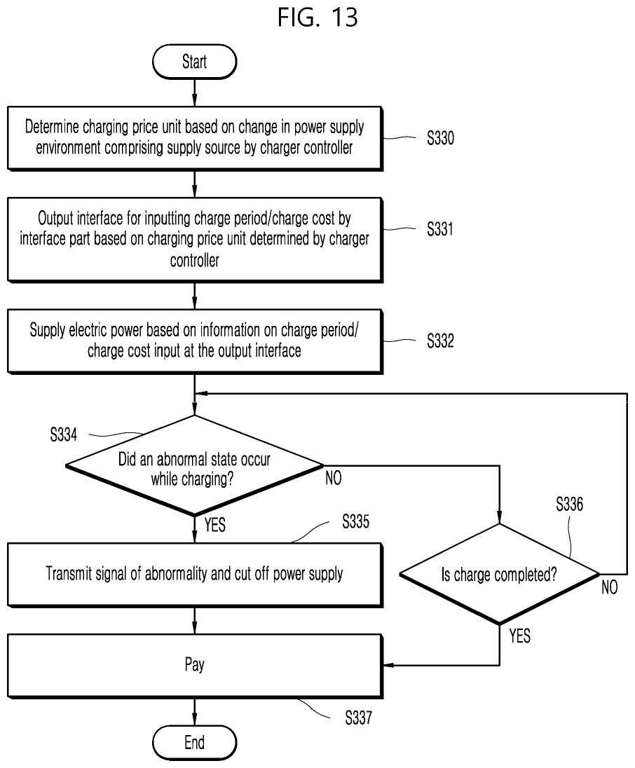

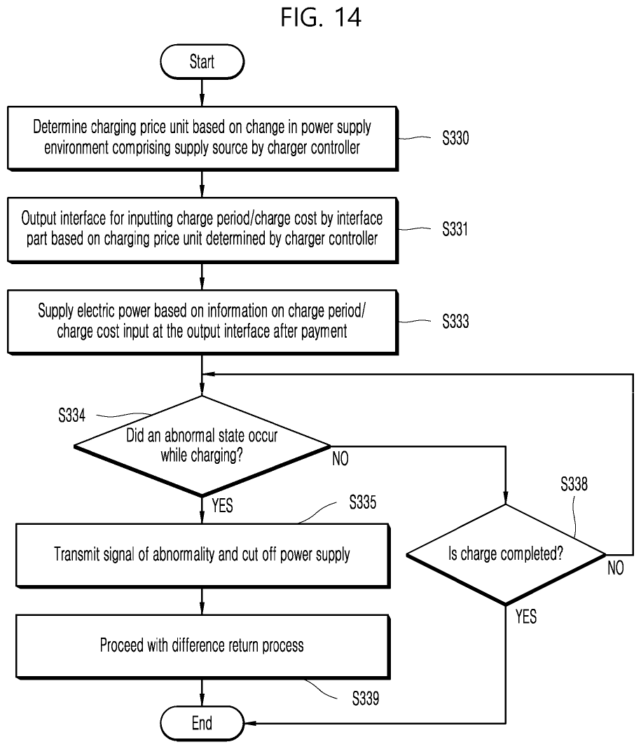

FIGS. 13 and 14 are views showing the process in which the charger controller 550 determines a charging price unit depending on a supply source and determines a maximum charge period or a maximum charge cost, based on information on an expected supply amount of a supply source.

FIG. 13 is a view showing the process in which the charger of one embodiment displays an interface required for charging or payment. FIG. 13 shows the process in which a payment is performed after charge. The user may select a unit price of charge, displayed by the interface part 510 of the charger 50, based on a charge amount, a charge period and the like. Options that can be selected may vary depending on high-speed/low-speed charge in the charge methods, and a change in the options may lead to a change in the unit price of charge.

The charger controller 550 determines a charging price unit depending on a change in a supply environment comprising a supply source (S330). If the grid (the power source) is a supply source and a reliable supply of electric power is expected, the charger controller 550 may determine a charging price unit for grid charge, based on grid charge.

If the grid (the power source) is a supply source but the ESS supplies electric power since a reliable supply of electric power is not expected, the charger controller 550 may determine a charging price unit for grid charge up to a predetermined charge amount, and a charging price unit for ESS charge over the predetermined charge amount.

If the ESS is a supply source and a reliable supply of electric power is expected, the charger controller 550 may determine a charging price unit for ESS charge, based on ESS charge.

If the ESS is a supply source and a reliable supply of electric power is not expected, the charger controller 550 may determine a charging price unit for ESS charge up to an ESS charged amount.

The charger controller 550 may predict potential power consumption, based on a current state of electricity use and a history of electricity use.

Then the interface part 510 outputs an interface for inputting a charge period/a charge cost, based on the charging price unit determined by the charger controller 550 (S331). The interface part 510 may display an interface that allows the user to input a charge period or a charge cost. In addition, the interface part 510 may provide an interface for inputting a charge amount or demand for full charging.

Then electric power is supplied based on information on the charge period/the charge cost input to the interface that is output at the interface part 510 (S332). The power supply proceeds after the user inputs the charge period or the charge cost.

Additionally, the charger controller 550 continues to monitor whether abnormalities occur during charge (S334). The abnormalities comprise a rapid change in the amount of electric power provided by the grid or the ESS as well as abnormalities during charge.

If an abnormality occurs (S334), the charger controller 550 transmits a signal of an abnormality and cuts off a power supply (S335). The signal of an abnormality may be transmitted to the ESS or a system and the like regarding the power source of the grid.

If the power supply is cut off due to an abnormality, a payment of electric power that has been supplied so far proceeds (S337).

If no abnormality occurs (S334), the charger controller 550 continues to perform charge, and after the charge is completed (S336), proceeds with a payment (S337). If the charge is not completed, the charger controller 550 proceeds with the charge.

FIG. 14 is a view showing the process in which the charger of another embodiment displays an interface required for charging or charge. FIG. 14 shows a process of proceeding with a payment before charge. The user may select a unit price of charge, displayed by the interface part 510 of the charger 50, based on a charge amount, a charge period and the like. Options that can be selected depending on high-speed charge/low-speed charge in the charge methods may vary, and a change in the options may lead to a change in the unit price of charge.

Details of steps 330 and 331 are the same as those described with reference to FIG. 13.

Then a power supply proceeds after a payment is made based on information on the charge period/charge cost input at the interface that is output at the interface part 510 (S333). Charge proceeds after the user inputs the charge period or the charge cost and makes a payment based on the charge period or the charge cost.

Additionally, the charger controller 550 continues to monitor whether an abnormality occurs during the charge (S334). The abnormalities comprise a rapid change in the amount of electric power provided by the grid or the ESS as well as abnormalities during the charge.

If an abnormality occurs (S334), the charger controller 550 transmits a signal of an abnormality and cuts off a power supply (S335). The signal of an abnormality may be transmitted to the ESS or a system and the like regarding the power source of the grid.

If the power supply is cut off due to an abnormality, the controller 550 proceeds with the process of returning a difference between the payment of electric power that has been supplied so far and the payment of electric power in step 333 since the amount of electric power that has been supplied so far is less than the amount of electric power that is paid in step 333 (S339).

If no abnormality occurs (S334), the charger controller 550 continues to perform charge, and after the charge is completed (S338), stops the charge. If the charge is not completed, the charger controller 550 proceeds with the charge.

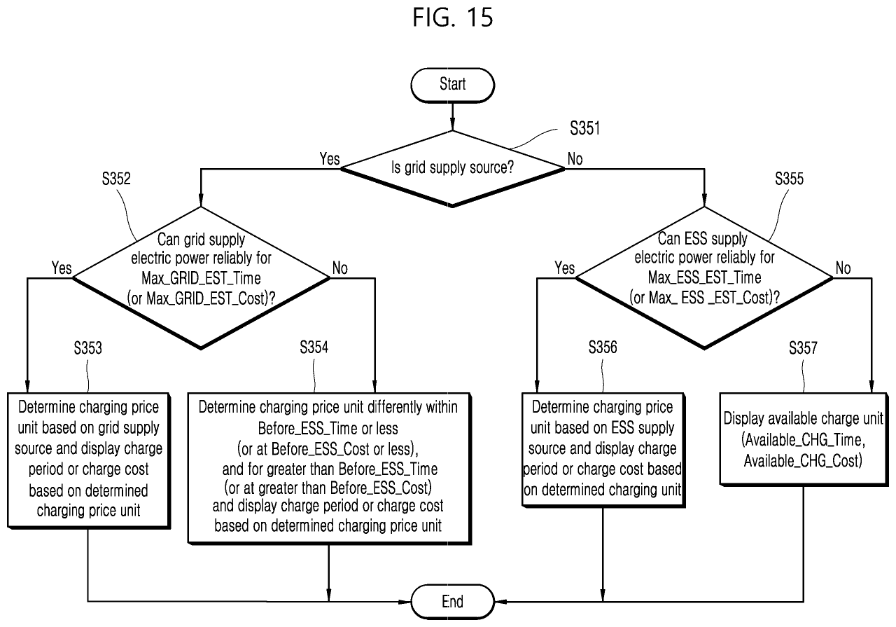

FIG. 15 is a view showing the process of determining a charging price unit according to one embodiment of the present invention. The charger controller 550 may determine the charging price unit differently, depending on whether the grid is a supply source or the ESS is a supply source (S351). The charger controller 550 determines whether the grid (the power source) is a supply source and whether the supply source is supplied reliably, within Max_GRID_EST_Time or Max_GRID_EST_Cost (S352).

Max_GRID_EST_Time denotes the period for which the grid can perform charge at a maximum level. Max_GRID_EST_Cost denotes the cost of which the grid can perform charge at a maximum level.

When ascertaining that a reliable supply is ensured, the charger controller 550 determines the charging price unit, based on the grid supply source, and displays a charge period or a charge cost, based on the charging price unit (S353).

When ascertaining that the grid (the power source) is a supply source and that the ESS is likely to be used as a supply source since electric power is not supplied reliably within Max_GRID_EST_Time(or Max_GRID_EST_Cost), in step 352, the charger controller 550 performs step 354.

That is, the charger controller 550 determines a charging price unit depending on Before_ESS_Time(or Before_ESS_Cost) or less and depending on greater than Before_ESS_Time(or Before_ESS_Cost), and displays a charge period or a charge cost, based on the charging price unit.

Before_ESS_Time denotes the period for which the grid can perform charge at a maximum level without the ESS's supply of electric power. Before_ESS_Cost denotes the cost of which the grid can perform charge at a maximum level without the ESS's supply of electric power.

That is, the charger controller 550 determines a charging price unit, based on the grid supply source, regarding a period/cost that are Before_ESS_Time(or Before_ESS_Cost) or less, and displays a charge period or a charge cost, based on the charging price unit.

Further, the charger controller 550 determines a charging price unit, based on the ESS supply source, regarding an extra period/cost over the Before_ESS_Time(or Before_ESS_Cost), and displays a charge period or a charge cost, based on the charging price unit.

Further, when ascertaining that the ESS is a supply source instead of the grid in step 352, the charger controller 550 determines whether the ESS is a supply source and whether electric power is supplied reliably from the ESS, within the Max_ESS_EST_Time(or Max_ESS_EST_Cost) (S355).

Max_ESS_EST_Time denotes the period for which the ESS can perform charge at a maximum level, and Max_ESS_EST_Cost denotes the cost of which the ESS can perform charge at a maximum level.

When ascertaining that a reliable supply is ensured, the charger controller 550 determines a charging price unit, based on the ESS supply source, and displays a charge period or a charge cost, based on the charging price unit (S356).

Further, when ascertaining that the ESS is a supply source and that electric power is unlikely to be supplied reliably, within the Max_ESS_EST_Time(or Max_ESS_EST_Cost), in step 355, the charger controller 550 performs step 357.

At this time, the charger controller 550 displays Available_CHG_Time, Available_CHG_Cost that are possible charge units (S357).

Description of FIG. 15 is summarized as follows.

The charger controller 550 determines a charging price unit, based on the grid supply source, if the grid is a supply source and supplies electric power for a maximum charge period Max_GRID_EST_Time or greater or at a maximum charge cost Max_GRID_EST_Cost or greater (S353).

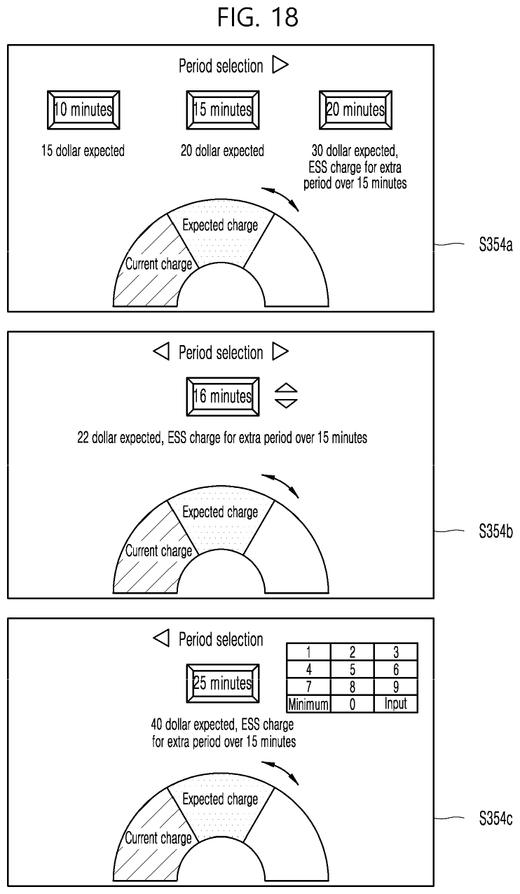

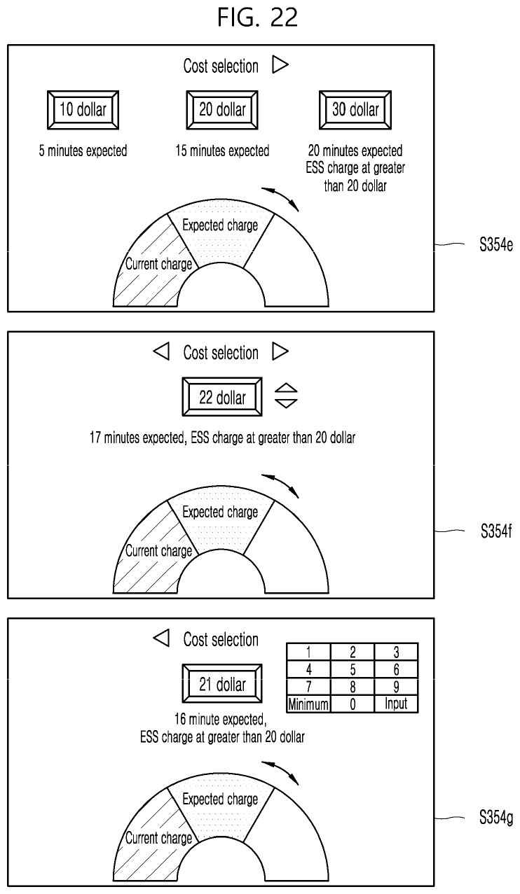

The charger controller 550 determines a first charging price unit, based on the grid supply source, regarding a charge period and a charge cost that are a first reference period or less or a first charge cost or less, if the grid is a supply source and cannot not supply electric power for the maximum charge period Max_GRID_EST_Time or greater or at the maximum charge cost Max_GRID_EST_Cost or greater. Additionally, the charger controller 550 determines a second charging price unit, based on the energy storage device supply source, regarding an extra charge period and an extra charge cost over the first reference period or the first charge cost (S354). In FIG. 18 described hereafter, a first reference period is 15 minutes, and in FIG. 22 described hereafter, a first reference cost is 20 dollars. In FIGS. 18 and 22 described hereafter, an example of a difference between the first charging price unit and the second charging price unit is provided.

The charger controller 550 determines a charging price unit, based on the energy storage device supply source, if the energy storage device is a supply source, and capable of supplying electric power for the maximum charge period Max_ESS_EST_Time or greater or at the maximum charge cost Max_ESS_EST_Cost or greater (S356).

The charger controller 550 determines a charging price unit, based on the energy storage device supply source, only regarding a charge period or a charge cost that is the first reference period or less or the first charge cost or less, if the energy storage device is a supply source, and not capable of supplying electric power for the maximum charge period Max_ESS_EST_Time or greater or at the maximum charge cost Max_ESS_EST_Cost or greater. Further, the charger controller 550 may control the interface part 510 such that a payment is not made for an extra charge period or an extra charge cost over the first reference period or the first charge cost.

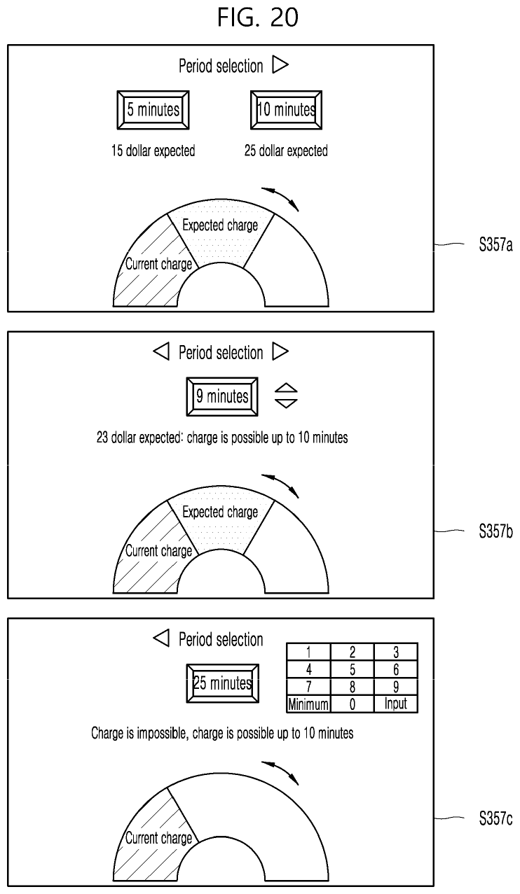

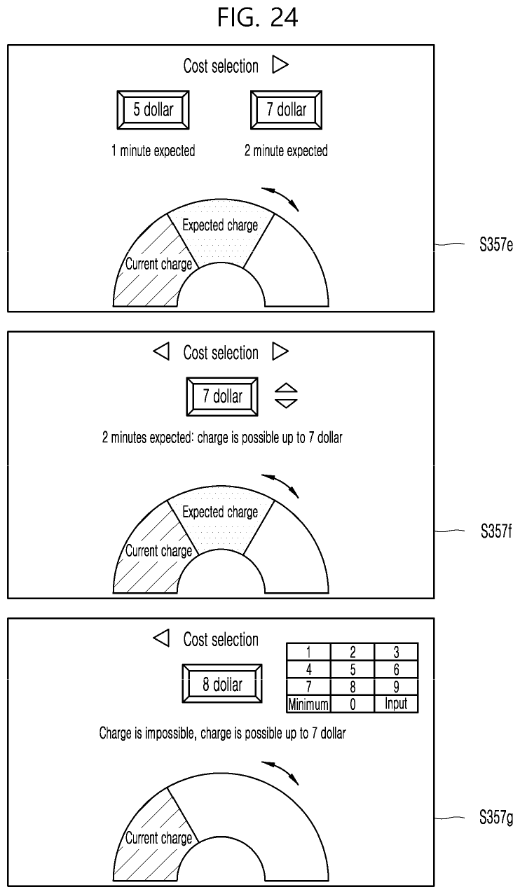

In FIG. 20 described hereafter, a first reference period is 10 minutes, and in FIG. 24 described hereafter, a first reference cost is 7 dollars. In FIGS. 20 and 24 described hereafter, an example of a difference between the first charging price unit and the second charging price unit is provided.

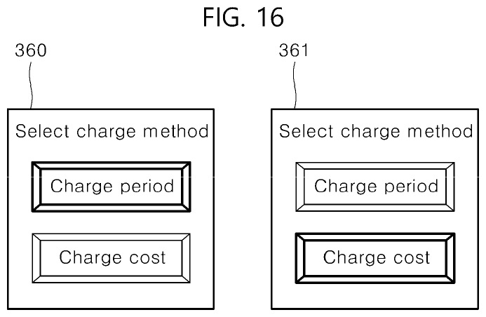

FIG. 16 shows an interface for selecting a charge method in one embodiment. Reference numeral 360 indicates an interface that shows the user selects a charge period, the time for charging. Reference numeral 361 indicates an interface that shows the user selects a charge cost, the cost for charging.

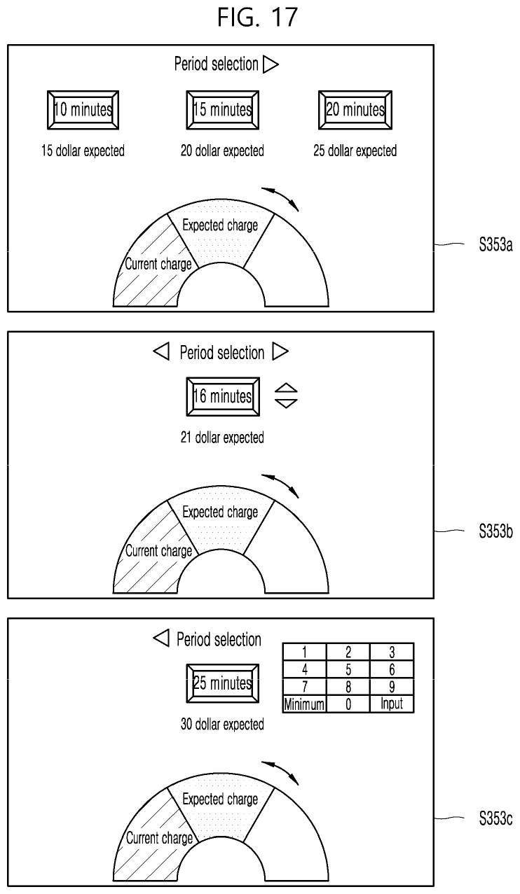

FIGS. 17 to 24 are views showing a charge interface according to one embodiment of the present invention.

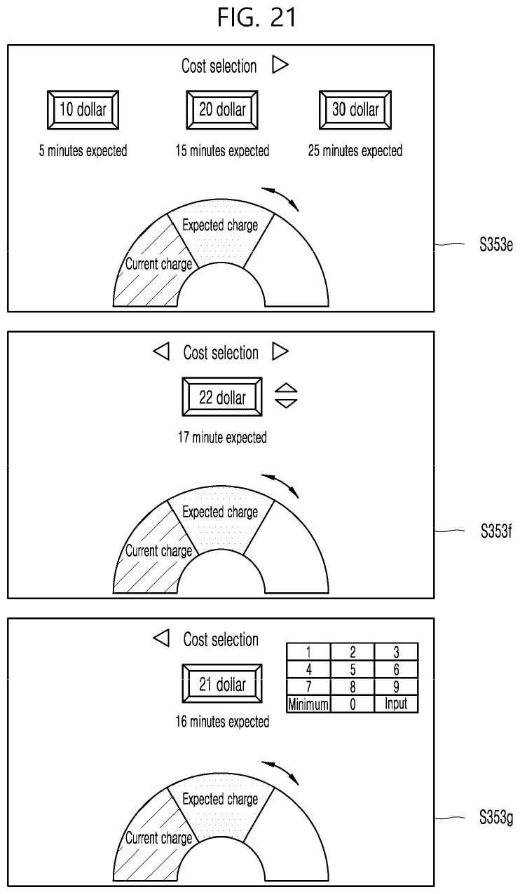

FIGS. 17 and 21 show an interface provided by the interface part 510, in step 353 of FIG. 15.

FIGS. 18 and 22 show an interface provided by the interface part 510, in step 354 of FIG. 15.

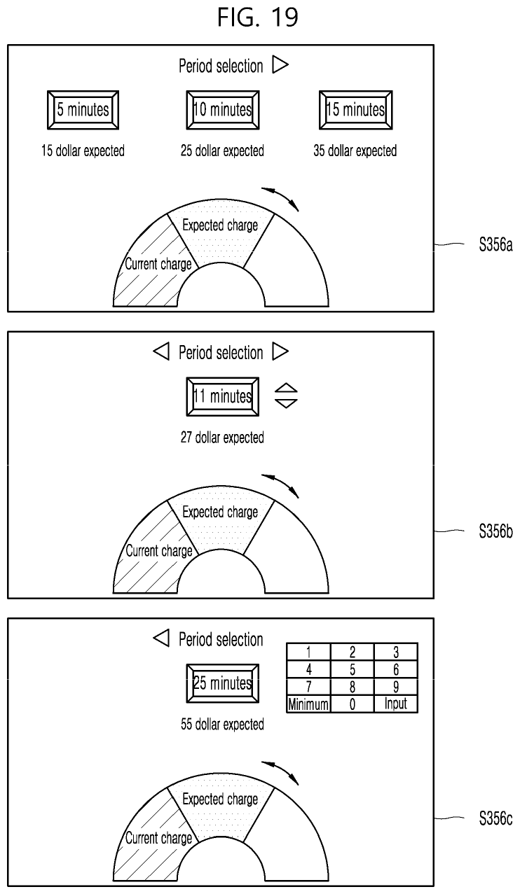

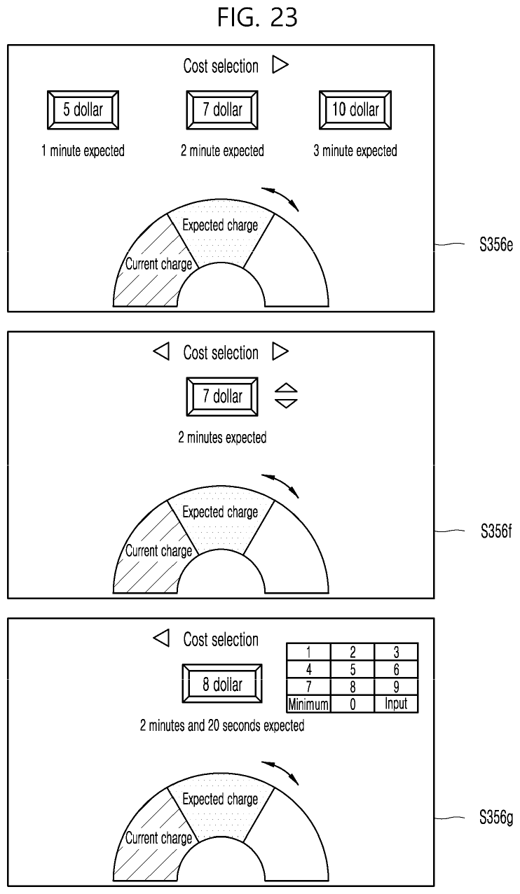

FIGS. 19 and 23 show an interface provided by the interface part 510, in step 356 of FIG. 15.

FIGS. 20 and 24 show an interface provided by the interface part 510, in step 357 of FIG. 15.

A triangle disposed on the left or the right of the phrase of time selection or cost selection at each interface indicates a button for displaying another interface.

FIGS. 17 to 20 show an interface that is displayed at a time of selecting a “Charge period” as indicated by 360 of FIG. 16. At this time, the interface part 510 may output an interface for selecting or inputting a charge period according to the charge period method, and the interface part 510 may also output an expected charge cost corresponding to the charge period.

Specifically, the charge period method comprises one or more of a method (S353a, S354a, S356a, S357a) of outputting an interface for selecting a charge period by the interface part 510, a method (S353b, S354b, S356b, S357b) of outputting an interface for increasing or decreasing the charge period by the interface part, or a method (S353c, S354c, S356c, S357c) of outputting an interface for receiving the charge period as a number by the interface part 510.

FIGS. 21 to 24 show an interface that is displayed at a time of selecting a “Charge cost” as indicated by 361 of FIG. 16. At this time, the interface part 510 may output an interface for selecting or inputting a charge cost according to the charge cost method, and the interface part 510 may also output an expected charge period corresponding to the charge cost.

Specifically, the charge cost method comprises one or more of a method (S353e, S354e, S356e, S357e) of outputting an interface for selecting a charge cost by the interface part 510, a method (S353f, S354f, S356f, S357f) of outputting an interface for increasing or decreasing the charge cost by the interface part, or a method (S353g, S354g, S356g, S357g) of outputting an interface for receiving the charge cost as a number by the interface part 510.

Hereafter, FIG. 17 is described specifically.

Step 353 relates to the case where electric power is supplied from the grid reliably, and charge is possible, within Max_GRID_EST_Time(or Max_GRID_EST_Cost). Accordingly, the interface part 510 may output any one of the interfaces in S353a, S353b and S353c, depending on a charging price unit for grid charge. A basic charging price unit for grid charge is 10 minutes and 15 dollars, and the charging price unit for grid charge increases by 5 dollar per 5 minutes.

The interface of step 353a displays a period, based on a unit (10 minutes, 15 minutes, and 20 minutes). Additionally, a charge cost is displayed respectively at the lower side of each unit period. For example, if the unit period of 10 minutes is selected, the charge cost is 15 dollars, if the unit period of 15 minutes is selected, the charge cost is 20 dollar, and if the unit period of 20 minutes is selected, the charge cost is 25 dollar. If the triangle on the right of “Time Selection” of step 353a is selected, the interface of step 353b may be displayed.

The interface of step 353b is used to increase or decrease a period, based on a 1-minute unit. The period increases or decreases by pressing the upper/lower triangle on the right of the area where 16 minutes is displayed. Accordingly, the charge cost is calculated to be 21 dollars. If the user presses the lower triangle, the charge period decreases to 15 minutes, and the charge cost of 20 dollar is displayed. If the triangle on the right of “Time Selection” of step 353b is selected, the interface of step 353c may be displayed. If the triangle on the left of “Time Selection” of step 353b is selected, the interface of step 353a may be displayed.

In step 353c, a pad for inputting a number may be displayed, and a period may be input. If a number is selected and then the “Input” button is selected, a charge period and an expected cost are displayed based on the selection. If the triangle on the left of “Time Selection” of step 353c is selected, the interface of step 353b may be displayed.

A current charge amount and an expected charge amount based on the period selected by the user are displayed at the lower end of steps 353a, 353b and 353c. As the user selects a certain period, an expected charge cost range may change.

Hereafter, FIG. 18 is described specifically.

Step 354 relates to the case where the grid (the power source) is a supply source and the ESS can be used since a reliable power supply from the grid is not ensured within Max_GRID_EST_Time(or Max_GRID_EST_Cost). That is, the controller 550 determines a charging price unit, and based on the charging price unit, displays a charge period or a charge cost differently, depending on Before_ESS_Time(or Before_ESS_Cost) or less and depending on greater than Before_ESS_Time(or Before_ESS_Cost).

In FIG. 18, Before_ESS_Time is 15 minutes.

Accordingly, the interface part 510 may output any one of the interfaces of S354a, S354b and S354c, based on the charging price unit for grid charge, in the case of a charge period of 15 minutes or less, and output any one of the interfaces of S354a, S354b and S354c, based on the charging price unit for ESS charge, in the case of an extra charge period over 15 minutes. A basic charging price unit for grid charge is 10 minutes and 15 dollars, and the charging price unit for grid charge increases by 5 dollar per 5 minutes. The charging price unit for ESS charge increases by 10 dollar per 5 minutes with respect to the extra period over 15 minutes.

The interface of step 354a displays a period, based on a unit (10 minutes, 15 minutes, and 20 minutes). Additionally, a charge cost is displayed respectively at the lower side of each unit period. For example, if the unit period of 10 minutes is selected, the charge cost is 15 dollars, and if the unit period of 15 minutes is selected, the charge cost is 20 dollar. If the unit period of 20 minutes is selected, the charge cost is 300 dollars since the charging price unit for ESS charge is applied for the extra period over 15 minutes. If the triangle on the right of “Time Selection” of step 354a is selected, the interface of step 354b may be displayed.

The interface of step 354b is used to increase or decrease a period, based on a 1-minute unit. The period increases or decreases by pressing the upper/lower triangle on the right of the area where 16 minutes is displayed. Accordingly, the charge cost is calculated to be 22 dollars. If the user presses the lower triangle, the charge period decreases to 15 minutes, and the charge cost of 20 dollar is displayed. A message indicating that ESS charge is performed with respect to an extra period over 15 minutes is displayed, and the charging price unit increases by 10 dollars per 1 minute. If the triangle on the right of “Time Selection” of step 354b is selected, the interface of step 354c may be displayed. If the triangle on the left of “Time Selection” of step 354b is selected, the interface of step 354a may be displayed.

In step 354c, a pad for inputting a number may be displayed, and a period may be input. If a number is selected and then the “Input” button is selected, a charge period and an expected cost are displayed based on the selection. The message indicating that ESS charge is performed with respect to the extra period over 15 minutes is displayed, and the charging price unit increases by 10 dollars per 1 minute. If the triangle on the left of “Time Selection” of step 354c is selected, the interface of step 354b may be displayed.

A current charge amount and an expected charge amount based on the period selected by the user are displayed at the lower end of step 354a, 354b and 354c. As the user selects a certain period, an expected charge cost range may change.

Hereafter, FIG. 19 is described specifically.

Step 356 relates to the case where electric power is supplied from the ESS reliably and charge is possible, within Max_ESS_EST_Time(or Max_ESS_EST_Cost). Accordingly, the interface part 510 may output any one of the interfaces in S356a, S356b and S356c, depending on a charging price unit for ESS charge. A basic charging price unit for ESS charge is 5 minutes and 15 dollars, and the charging price unit for ESS charge increases by 10 dollar per 5 minutes.

The interface of step 356a displays a period, based on a unit (5 minutes, 10 minutes, and 15 minutes). Additionally, a charge cost is displayed respectively at the lower side of each unit period. For example, if the unit period of 5 minutes is selected, the charge cost is 15 dollars, if the unit period of 10 minutes is selected, the charge cost is 25 dollar, and if the unit period of 15 minutes is selected, the charge cost is 35 dollar. If the triangle on the right of “Time Selection” of step 356a is selected, the interface of step 356b may be displayed.

The interface of step 356b is used to increase or decrease a period, based on a 1-minute unit. The period increases or decreases by pressing the upper/lower triangle on the right of the area where 11 minutes is displayed. Accordingly, the charge cost is calculated to be 27 dollars. If the user presses the lower triangle, the charge period decreases to 10 minutes, and the charge cost of 25 dollar is displayed. If the triangle on the right of “Time Selection” of step 356b is selected, the interface of step 356c may be displayed. If the triangle on the left of “Time Selection” of step 356b is selected, the interface of step 356a may be displayed.

In step 356c, a pad for inputting a number may be displayed, and a period may be input. If a number is selected and then the “Input” button is selected, a charge period and an expected cost are displayed based on the selection. If the triangle on the left of “Time Selection” of step 356c is selected, the interface of step 356b may be displayed

A current charge amount and an expected charge amount based on the period selected by the user are displayed at the lower end of step 356a, 356b and 356c. As the user selects a certain period, an expected charge cost range may change.

Hereafter, FIG. 20 is described specifically.

Step 357 relates to the case where electric power is supplied from the ESS, and charge is possible, within Available_CHG_Time and Available_CHG_Cost that are available charge units. Available_CHG_Time is 10 minutes, and a charge period less than 10 minutes may be selected.

Accordingly, the interface part 510 may output any one of the interfaces of step 357a, S357b and S357c, depending on the charging price unit for ESS charge and the available charge units. A basic charging price unit for ESS charge is 5 minutes and 15 dollar, and the charging price unit for ESS charge increases by 10 dollar per 5 minutes.

The interface of step 357a displays a period less than 10 minutes as 5 minutes and 10 minutes. Additionally, a charge cost is respectively displayed at the lower side of each unit period. For example, if the unit period of 5 minutes is selected, the charge cost is 15 dollar, and if the unit period of 10 minutes is selected, the charge cost is 25 dollar. If the triangle on the right of “Time Selection” of step 357a is selected, the interface of step 357b may be displayed.

The interface of step 357b is used to increase or decrease a period, based on a 1-minute unit. The period increases or decreases by pressing the upper/lower triangle on the right of the area where 9 minutes is displayed. Accordingly, the charge cost is calculated to be 23 dollars. If the user presses the upper triangle, the charge period increases to 10 minutes, and the charge cost of 25 dollar is displayed. Further, a message indicating that charge can be performed up to 10 minutes is displayed.

If the triangle on the right of “Time Selection” of step 357b is selected, the interface of step 357c may be displayed. If the triangle on the left of “Time Selection” of step 357b is selected, the interface of step 357a may be displayed.

In step 357c, a pad for inputting a number may be displayed, and a period may be input. If a number is selected and then the “Input” button is selected, a charge period and an expected cost are displayed based on the selection. If 25 minutes is input, a message indicating that charge is possible up to 10 minutes is displayed. If the triangle on the left of “Time Selection” of step 357c is selected, the interface of step 357b may be displayed.

A current charge amount and an expected charge amount based on the period selected by the user are displayed at the lower end of step 357a, 357b and 357c. As the user selects a certain period, an expected charge cost range may change.

Hereafter, FIG. 21 is described specifically.

Step 353 relates to the case where electric power is supplied from the grid reliably, and charge is possible, within Max_GRID_EST_Cost(or Max_GRID_EST_Time). Accordingly, the interface part 510 may output any one of the interfaces of step 353e, 353f and 353g, depending on the charging price unit for grid charge.

The interface of step 353e displays a cost as units of 10 dollars, 20 dollars and 30 dollars. Additionally, an expected charge period is respectively displayed at the lower side of each unit cost. For example, if the unit cost of 10 dollar is selected, the charge period is 5 minutes, if the unit cost of 20 dollar is selected, the charge period is 15 minutes, and if the unit cost of 30 dollar is selected, the charge period is 25 minutes. If the triangle on the right of “Cost Selection” of step 353e is selected, the interface of step 353f may be displayed.

The interface of step 353f is used to increase or decrease based on 1-dollar unit. If the upper/lower triangle on the right of the area where 22 dollar is displayed is pressed, the cost increases or decreases. Accordingly, a charge period is calculated to be 17 minutes. If the user presses the lower triangle, the charge cost decreases to 21 dollars, and the period of 16 minutes is displayed. If the triangle on the right of “Cost Selection” of step 353f is selected, the interface of step 353g may be displayed. If the triangle on the left of “Cost Selection” of step 353f is selected, the interface of step 353e may be displayed.

In step 353g, a pad for inputting a number may be displayed, and a cost may be input. If a number is selected and then the “Input” button is selected, a charge cost and an expected period are displayed based on the selection. If the triangle on the left of “Cost Selection” of step 353g is selected, the interface of step 353f may be displayed.

A current charge amount and an expected charge amount based on the cost selected by the user are displayed at the lower end of step 353e, 353f and 353g. As the user selects a certain cost, an expected charge period range may change.

Hereafter, FIG. 22 is described specifically.

Step 354 relates to the case where the grid (the power source) is a supply source, and the ESS can be used since a reliable power supply from the grid is not ensured, within Max_GRID_EST_Cost(or Max_GRID_EST_Time). That is, the controller 550 determines a charging price unit, and based on the charging price unit, displays a charge period or a charge cost differently, depending on Before_ESS_Time(or Before_ESS_Cost) or less and depending on greater than Before_ESS_Time(or Before_ESS_Cost).

In FIG. 22, Before_ESS_Cost is 20 dollars.

Accordingly, the interface part 510 may output any one of the interfaces of 354e, 354f and 354g, based on the charging price unit for grid charge, in the case of a cost of 20 dollar or less, and output any one of the interfaces of 354e, 354f and 354g, based on the charging price unit for ESS charge, in the case of an extra cost over 20 dollars. A basic charging price unit for grid charge is 10 dollar and 5 minutes, and the expected period increases by 10 minutes per 10 dollars. The charging price unit of ESS charge increases by 10 dollars per 1 minute with respect to an extra cost over 20 dollar.

The interface of step 354e displays a cost as units of 10 dollars, 20 dollar and 30 dollars. Additionally, a charge cost is respectively displayed at the lower side of each unit period. For example, if the unit cost of 10 dollar is selected, the expected charge period is 5 minutes, and if the unit cost of 20 dollar is selected, the charge period is 15 minutes. If the unit cost of 30 dollar is selected, the ESS charge unit is applied for an extra cost over 20 dollars, and the charge period may be 20 minutes. In the case of high-speed ESS charge, the charge period may decrease. In the case of low-speed ESS charge, the charge period may be expected to be similar to the charge period of grid charge.

If the triangle on the right of “Cost Selection” of step 354e is selected, the interface of step 354f may be displayed.

The interface of step 354f is used to increase or decrease a cost based on 1-dollar units. If the upper/lower triangle on the right of the area where 22 dollars is displayed is pressed, the cost increases. Accordingly, an expected charge period is calculated to be 17 minutes. If the user presses the lower triangle, the charge cost decreases to 21 dollars, and the expected period of 16 minutes may be displayed. A message indicating that ESS charge is performed with respect to an extra cost except for 20 dollars may be displayed. If the triangle on the right of “Cost Selection” of step 354f is selected, the interface of step 354g may be displayed. If the triangle on the left of “Cost Selection” of step 354f is selected, the interface of step 354e may be displayed.

In step 354g, a pad for inputting a number may be displayed, and a cost may be input. If a number is selected and then the “Input” button is selected, a charge cost and an expected period are displayed based on the selection. A message indicating that ESS charge is performed with respect to an extra cost over 20 dollars is displayed. Accordingly, the expected period may change. If the triangle on the left of “Cost Selection” of step 353g is selected, the interface of step 353f may be displayed. If the triangle on the left of “Cost Selection” of step 354g is selected, the interface of step 354f may be displayed.

A current charge amount and an expected charge amount based on the cost selected by the user are displayed at the lower end of step 354e, S354f and S354g. As the user selects a certain cost, an expected charge period range may change.

Hereafter, FIG. 23 is described specifically.

Step 356 relates to the case where electric power is supplied from the ESS reliably, and charge is possible, within Max_ESS_EST_Cost(or Max_ESS_EST_Time). Accordingly, the interface part 510 may output any one of the interfaces of 356e, S356f and S356g, depending on a charging price unit of ESS charge. The charging price unit of ESS charge is calculated based on an expected charge cost of 5 dollars and an expected charge period of 1 minute.

The interface of step 356e displays a cost as units of 5 dollars, 7 dollars and 10 dollars. Additionally, an expected charge period is respectively displayed at the lower side of each unit cost. For example, if the unit cost of 5 dollars is selected, the charge period is 1 minute, if the unit cost of 7 dollars is selected, the charge period is 2 minutes, and if the unit cost of 10 dollars is selected, the charge period is 3 minutes. If the triangle on the right of “Cost Selection” of step 356e is selected, the interface of step 356f may be displayed.

The interface of step 356f is used to increase or decrease a cost based on a 1-dollar unit. If the upper/lower triangle on the right of the area where 7 dollars is displayed is pressed, the cost increases. Accordingly, a charge period is calculated to be 2 minutes. If the user presses the lower triangle, the charge cost decreases to 6 dollars, and the period of 1 minute and 50 seconds is displayed. If the triangle on the right of “Cost Selection” of step 356f is selected, the interface of step 356g may be displayed. If the triangle on the left of “Cost Selection” of step 356f is selected, the interface of step 356e may be displayed.

In step 356g, a pad for inputting a number may be displayed, and a cost may be input. If a number is selected and then the “Input” button is selected, a charge cost and an expected period are displayed based on the selection. If the triangle on the left of “Cost Selection” of step 356g is selected, the interface of step 356f may be displayed.

A current charge amount and an expected charge amount based on the cost selected by the user are displayed at the lower end of step 356e, 356f and 356g. As the user selects a certain cost, an expected charge period range may change.

Hereafter, FIG. 24 is described specifically.

Step 357 relates to the case where electric power is supplied from the ESS, and charge is possible, within (Available_CHG_Time, Available_CHG_Cost) that are available charge units. Available_CHG_Cost is 7 dollars. Accordingly, a charge period may be selected within 7 dollars.

The interface part 510 may output any one of the interfaces of 357e, 357f and 357g, depending on the charging price unit of ESS charge and the available charge units.

The interface of step 357e displays charge costs of 5 dollar and 7 dollars. Additionally, an expected charge period is respectively displayed at the lower side of each unit cost. For example, if the unit cost of 5 dollars is selected, the charge period is 1 minute, and if the unit cost of 7 dollars is selected, the charge period is 2 minutes, If the triangle on the right of “Cost Selection” of step 357e is selected, the interface of step 357f may be displayed.

The interface of step 357f is used to increase or decrease a cost based on 1-dollar units. If the upper/lower triangle on the right of the area where 7 dollars is displayed is pressed, the cost increases. Accordingly, a charge period is calculated to be 2 minutes. If the user presses the upper triangle, charge is possible up to 7 dollars, and the cost does not increase any longer.

If the triangle on the right of “Cost Selection” of step 357f is selected, the interface of 357g may be displayed. If the triangle on the left of “Cost Selection” of step 357f is selected, the interface of step 357e may be displayed.

In step 357g, a pad for inputting a number may be displayed, and a cost may be input. If a number is selected and then the “Input” button is selected, a charge period and an expected cost are displayed based on the selection. If 8 dollar is input, a massage indicating that charge is possible up to 7 dollars is displayed. If the triangle disposed on the left of the “Cost Selection” of step 357g is selected, the interface of step 357f may be displayed.

A current charge amount and an expected charge amount based on the cost selected by the user are displayed at the lower end of step 357e, 357f and 357g. As the user selects a certain cost, an expected charge period range may change.

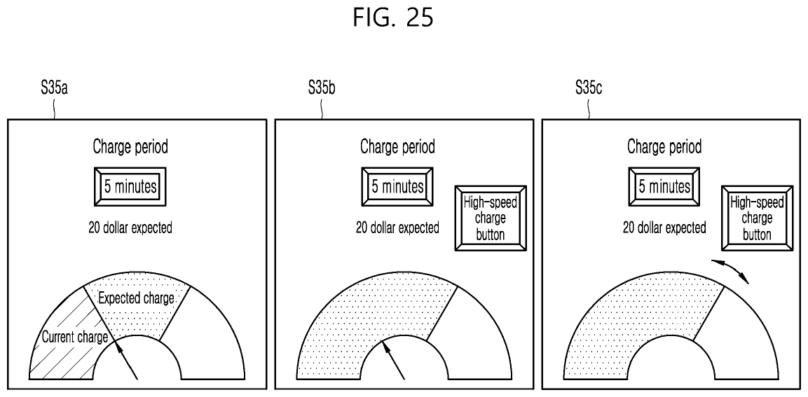

FIG. 25 is a view showing a charge process after charge starts in one embodiment. Step 35a shows a current charge state after a charge period is set and then charge starts. The interface part 510 displays an initial state of a vehicle and the amount of supplied power. The arrow indicating a current charge state moves to the right during charge and reaches the expected charge amount.

Step 35b shows a charge state after a charge period is set and then charge starts. The interface part 510 does not display an initial state of a vehicle, but displays an entire expected charge amount and displays a current charge state with an arrow.

Step 35c shows pie chart based on a method in which the surface area of the pie chart increases or decreases depending on the amount of supplied power.

A set charge cost may be displayed as illustrated in steps 35a to 35c. However, information on a cost is displayed first.

An interface “High-Speed Charge Button” is shown in steps 35b and 35c of FIG. If the user finds that a charge speed is slow during charge, the user touches the “High-Speed Charge Button” to give an instruction to perform high-speed charge and pays for the high-speed charge.

That is, if the charger controller confirms that the energy storage device can perform high-speed charge, while the charge part 530 performs charge, the interface part 510 may output an interface for selecting high-speed charge.

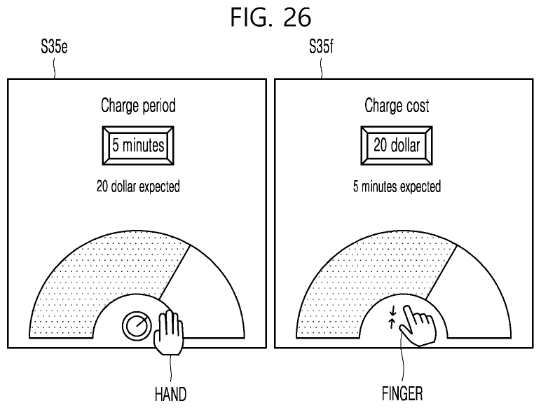

FIG. 26 is a view showing an interface for setting a charge amount in another embodiment. The interface of step 35e is based on a jog shuttle method in which the user touches the area displayed in the interface part 510 by using a hand (an instruction by a hand) and adjusts the size of the pie chart in the left-right direction to adjust a charge period. Step 35f involves adjusting the area displayed in the interface part 510 by a finger of the user to set a charge cost.

In the embodiment, before the user inputs a charge cost/charge period/charge amount, the charger 50 may display a maximum potential charge period/charge cost/charge amount, depending on a current load of the grid and the load state of another charger/except for the ESS. Additionally, in this process, the charger 50 may display information on the current charge state of a vehicle.

During charge, the charger 50 may display a charge period/charge cost/charge amount that are changed depending on a current load of the grid and the load state of another charger/except for the ESS.

Further, a charge method may be changed. For example, in the initial stage of charge, low-speed charge is performed due to the generation of a plurality of loads. However, during the charge, the plurality of loads disappears and the charger 50 may perform high-speed charge automatically. Further, as illustrated in FIG. 25, the user may select the high-speed charge button to perform high-speed charge.

In the embodiment, the charger 50 may perform charge in a stable manner in response to a change in the situation of power supply. The charger 50 may receive electric power supplied from the power grid and the energy storage device, under the control of the energy storage device, based on the switching or merging of power supply.

Additionally, the charger 50 may charge an object in need of charge, by using the supplied power.

Specifically, in the charge process, the charger 50 receives a selection input by the user by displaying a first screen interface (FIG. 16) for selecting any one of the charge cost method or the charge period method, on the screen thereof. Additionally, the charger 50 receives a selection input by the user by displaying detailed information on the charge period method or charge cost method at a second screen interface, which was selected at the first screen interface before displaying the second interface.

In the case of a charge period method, an example of the second screen interface is illustrated in FIGS. 17 to 20.

In the case of a charge cost method, an example of the second screen interface is illustrated in FIGS. 21 to 24.

As charge proceeds based on the detailed information on the charge period method or charge cost method selected through the second screen interface, information on a charge state may be displayed on the screen of the charger, through a third screen interface (FIG. 25).

The detailed information on the charge period method may comprise a plurality of icons for selecting a plurality of charge periods or an icon for inputting the number of a period. Drawings in relation to this are in FIGS. 17 to 20.

The detailed information on the charge cost method may comprise a plurality of icons for selecting a plurality of charge costs or an icon for inputting the number of a charge cost. Drawings in relation to this are in FIGS. 21 to 24.

Additionally, the charger 50 may display information on a charge state in which a current charge amount and an expected charge amount change in real time. An example in relation to this is in FIG. 25.

The interface of the charger 50 in the embodiments comprises an interface for the charge of an electric vehicle (EV) that is an object in need of charge.

When all elements of the embodiments of the subject matter in the present disclosure are described to be combined into one element or to operate in combination, the subject matter is not limited to the embodiments and all the elements can be selectively combined to operate within the scope of the present disclosure. All the elements can be embodied as independent hardware pieces, respectively, or some or all of the elements can be selectively combined and can be embodied as a computer program including a program module that performs some or all functions combined into one hardware piece or a plurality of hardware pieces. Codes or code segments of the computer program can be easily inferred by those skilled in the art. The computer program can be stored in a computer-readable recording medium and can be read and executed by a computer, whereby the embodiments of the subject matter can be realized. Examples of a storage medium having stored the computer program include storage mediums such as a magnetic recording medium, an optical recording medium, and a semiconductor recording medium. The computer program for realizing the embodiments of the subject matter includes a program module which is transmitted via an external device in real time.

Some embodiments disclosed herein may be described in the following manner.

For some embodiments that provide one or more interfaces or screens, at least one among the first screen interface, the second screen interface and the third screen interface is provided on at least one among the charger, an electric vehicle (EV) and an electronic device.

At least one embodiment provides a system comprising: an energy storage device connected to a power grid and having a plurality of batteries therein; and a power charger, having a user interface and operatively connected with and being controlled by the energy storage device, configured to provide electric power from at least one among the power grid and the batteries to an electric vehicle for charging thereof, wherein the batteries are capable of relatively high C-rate discharging, and wherein the power charger is capable low C-rate charging and relatively high C-rate charging of the electric vehicle depending upon an electric power situation detected by the energy storage device.

The C-rate of discharging is relatively high when compared to that of conventional lithium-based batteries and the C-rate of charging is relatively high when compared to that of conventional power chargers for electric vehicles.

The energy storage device continues to monitor an amount of electric power from the power grid during the high C-rate discharging to allow the power charger to perform the high C-rate charging of the electric vehicle.

The batteries are vanadium ion batteries that exhibit different electrochemical characteristics than vanadium-based redox flow batteries.

The electric power situation detected by the energy storage device is at least based upon a network of power measurement devices located throughout the system.

The embodiments and drawings set forth herein are provided as examples and should not be interpreted in a limited manner. Additionally, the scope of the present disclosure is to be defined according to the appended claims rather than the above description. Further, all the modifications or modified forms drawn from the meanings and scopes of the claims and the equivalents thereof should be interpreted as being included in the scope of the present disclosure.

What is claimed is:

1. A charger, comprising:
a power supply part receiving electric power from at least one supply source among a grid and an energy storage device;
an interface part providing an interface for selecting any one of a charge cost method or a charge period method, and an interface for setting a charge cost or a charge period, based on the selected charge cost or charge period method;
a charger controller determining a charging price unit of the charge cost or the charge period depending on a type of the supply source; and
a charge part proceeding with a power charge operation, based a charge period or a charge cost selected at the interface part.

2. The charger of claim 1, wherein the charger controller determines the charging price unit based on the supply source, and determines a maximum charge period or a maximum charge cost based on information on an expected electric power supply amount of the supply source.

3. The charger of claim 1, wherein if the grid as the supply source can supply electric power for a maximum charge period or greater, or can supply electric power at a maximum charge cost or greater, the charger controller determines the charging price unit based on the grid supply source.

4. The charger of claim 1, wherein if the grid as the supply source cannot supply electric power for a maximum charge period or greater, or cannot supply electric power at a maximum charge cost or greater, the charger controller determines a first charging price unit, for a first reference period or less, or for a first charge cost or less, based on the grid supply source, and determines a second charging price unit, for an extra period that exceeds the first reference period, or for an extra cost that exceeds the first charge cost, based on the energy storage device supply source.

5. The charger of claim 1, wherein if the energy storage device as the supply source can supply electric power for a maximum charge period or greater, or can supply electric power at a maximum charge cost or greater, the charger controller determines the charging price unit based on an energy storage device supply source.

6. The charger of claim 1, wherein if the energy storage device as the supply source cannot supply electric power for a maximum charge period or greater, or cannot supply electric power at a maximum charge cost or greater, the charger controller determines a charging price unit, only for a first reference period or less, or for at a first charge cost or less, based on the energy storage device supply source, and
the charger controller controls the interface part to not allow any payment, for an extra period that exceeds the first reference period, or for an extra cost that exceeds the first charge cost.

7. The charger of claim 1, wherein the interface part outputs an interface for selecting or inputting the charge period, based on the charge period method, and an expected charge cost corresponding to the charge period.

8. The charger of claim 7 wherein the charge period method comprises one or more of outputting an interface for selecting the charge period by the interface part, outputting an interface for increasing or decreasing the charge period by the interface part, or outputting an interface for receiving the charge period as a numerical value by the interface part.

9. The charger of claim 1, wherein the interface part outputs an interface for selecting or inputting the charge cost, based on the charge cost method, and an expected charge period corresponding to the charge cost.

10. The charger of claim 9, wherein the charge cost method comprises one or more of outputting an interface for selecting the charge cost by the interface part, outputting an interface for increasing or decreasing the charge cost by the interface part, or outputting an interface for inputting the charge cost as a numerical value by the interface part.

11. The charger of claim 1, wherein if the charger controller confirms that the energy storage device can perform a high-speed charge operation while the charge part performs a charge operation, the interface part outputs an interface for selecting the high-speed charge operation.

12. A method comprising:
providing a user interface in a charge method in which in response to a change in the situation of power supply, a charger receives electric power supplied from a power grid and an energy storage device under the control of the energy storage device, based on the switching or merging of power supply, and then performs power charging for an object in need of charging by using the supplied electric power, to provide a reliable power charging operation;
displaying a first screen interface for selecting any one of a charge cost method and a charge period method on a screen and receiving a user's input selection;
displaying a second screen interface for providing detailed information about the charge period method or the charge cost method selected via the first screen interface and receiving a user's input selection; and
displaying information about a charge state via a third screen interface as power charging proceeds based on the detailed information on the charge period method or the charge cost method selected via the second screen interface.

13. The method of claim 12, wherein the detailed information on the charge period method comprises a plurality of icons for selecting a plurality of charge periods or an icon for inputting the number of a period, and the detailed information on the charge cost method comprises a plurality of icons for selecting a plurality of charge costs or an icon for inputting the number of a charge cost.

14. The method of claim 13, wherein the information on a charge state indicates a current charge amount and an expected charge amount that change in real time.

15. The method of claim 14, wherein the object in need of charge is an electric vehicle (EV).

16. The method of claim 12, wherein a power supply network to which the charger connects to is a power supply network having two or more power supply sources comprising the grid and at least one energy storage device, the method, comprising:
receiving a request for power charge from the charger of the energy storage device used to charge an object comprising a chargeable battery;
comparing a total of an amount of electric power requested by the charger (Charge_Request) and an amount of power defined for primary usage (Primary_Usage) with a maximum amount of available electric power of the grid (Grid_Max);
performing a first procedure by the energy storage device if the maximum amount of available electric power of the grid (Grid_Max) is the total or less, and otherwise performing a second procedure by the energy storage device;
selectively performing the first procedure or the second procedure by the energy storage device, and providing electric power to the charger solely by the grid, or solely by the energy storage device, or by the grid and the energy storage device together.

17. The method of claim 16, wherein the amount of electric power defined for primary usage (Primary_Usage) relates to an amount of electric power used in a primary power region of the power grid.

18. The method of claim 16, wherein the first procedure comprises determining an amount of discharge power of the energy storage device and performing discharge, and assisting with an extra amount of the maximum amount of available electric power of the grid (Grid_Max).

19. The method of claim 16, wherein the second procedure comprises determining an amount of charge power of the energy storage device and performing charge if an amount of spare electric power of the grid is a reference value or greater, to use the spare electric power of the grid for charge, and putting the energy storage device in a discharge standby mode if the amount of spare electric power of the grid is the reference value or less.

20. The method of claim 12, wherein at least one among the first screen interface, the second screen interface and the third screen interface is provided on at least one among the charger, an electric vehicle (EV) and an electronic device.

21. A system comprising:
an energy storage device connected to a power grid and having a plurality of batteries therein; and
a power charger, having a user interface and operatively connected with and being controlled by the energy storage device, configured to provide electric power from at least one among the power grid and the batteries to an electric vehicle for charging thereof,
wherein the batteries are capable of relatively high C-rate discharging, and wherein the power charger is capable low C-rate charging and relatively high C-rate charging of the electric vehicle depending upon an electric power situation detected by the energy storage device.

22. The system of claim 21, wherein the C-rate of discharging is relatively high when compared to that of conventional lithium-based batteries and the C-rate of charging is relatively high when compared to that of conventional power chargers for electric vehicles.

23. The system of claim 21, wherein the energy storage device continues to monitor an amount of electric power from the power grid during the high C-rate discharging to allow the power charger to perform the high C-rate charging of the electric vehicle.

24. The system of claim 21, wherein the batteries are vanadium ion batteries that exhibit different electrochemical characteristics than vanadium-based redox flow batteries.

25. The system of claim 21, wherein the electric power situation detected by the energy storage device is at least based upon a network of power measurement devices located throughout the system.
